(19) United States
(12) Patent Application Publication
(10) Pub. No.: US 2024/0406979 A1
(43) Pub. Date: Dec. 5, 2024

(54) Method and Apparatus for Sidelink Resource Selection

(71) Applicant: Telefonaktiebolaget LM Ericsson (publ), Stockholm (SE)

(72) Inventors: Hieu Do, Järfälla (SE); Shehzad Ali Ashraf, Munich (DE); Jose Angel Leon Calvo, Munich (DE); Min Wang, Luleå (SE); Ricardo Blasco Serrano, Espoo (FI); Zhang Zhang, Beijing (CN)

(21) Appl. No.: 18/698,455

(22) PCT Filed: Oct. 11, 2022
(86) PCT No.: PCT/CN2022/124613

§ 371 Date: Apr. 4, 2024

(30) Foreign Application Priority Data
Oct. 12, 2021 (WO) PCT/CN2021/123375

(51) Int. Cl. H04W 72/25; H04W 76/28; H04W 88/04

(52) U.S. Cl. CPC H04W 72/25; H04W 76/28; H04W 88/04

(57) ABSTRACT

Embodiments of the present disclosure provide method and apparatus for sidelink resource selection. A method performed by a transmitting UE comprises obtaining at least one DRX active time of at least one RX UE. The method further comprises selecting one or more resources to create a SL grant based on the at least one DRX active time of the at least one RX UE. The method further comprises selecting a destination based on the at least one DRX active time of at least one RX UE and at least one resource in a created SL grant. A destination is associated with a single or multiple RX UEs. Selecting one or more resources to create a SL grant based on the at least one DRX active time of the at least one RX UE comprises: determining whether one or more available resources for creating the SL grant for data transmission fulfills at least one first condition, and selecting the one or more resources for creating a SL grant for data transmission from the one or more available resources identified by a resource identification procedure, based on the at least one DRX active time of the at least one RX UE. The at least one first condition comprises: an overlapping in a time domain occurs between the at least one DRX active time of at least one RX UE and the one or more available resources identified by a resource identification procedure.

### TECHNICAL FIELD

The non-limiting and exemplary embodiments of the present disclosure generally relate to the technical field of communications, and specifically to methods and apparatuses for sidelink (SL) resource selection.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example LTE (Long Term Evolution) and NR (new radio) as defined by 3rd Generation Partnership Project (3GPP), a Medium Access Control (MAC) entity may be configured with a discontinuous reception functionality that controls a monitoring activity of a user equipment (UE).

For LTE, as described in 3GPP TS 36.321 V16.2.0, the disclosure of which is incorporated by reference herein in its entirety, the MAC entity may be configured by RRC (Radio Resource Control) with a DRX functionality that controls the UE's PDCCH (Physical Downlink Control Channel) monitoring activity for the MAC entity's C-RNTI (Cell RNTI (Radio Network Temporary Identity)), TPC-PUCCH-RNTI (Transmit Power Control-Physical Uplink Control Channel-RNTI), TPC-PUSCH-RNTI (Transmit Power Control-Physical Uplink Shared Channel-RNTI), Semi-Persistent Scheduling C-RNTI (if configured), UL (uplink) Semi-Persistent Scheduling V-RNTI (vehicle RATI) (if configured), eIMTA-RNTI (Enhanced Interference Management and Traffic Adaptation-RNTI) (if configured), SL-RNTI (sidelink RNTI) (if configured), SL-V-RNTI (if configured), CC-RNTI (Common Control RNTI) (if configured), SRS-TPC-RNTI (Sounding Reference Symbols-Transmit Power Control-RNTI) (if configured), and AUL (Autonomous Uplink)C-RNTI (if configured).

For 5G (fifth generation) NR, the DRX procedures are described in clause 5.7 of 3GPP TS 38.321 V16.6.0, the disclosure of which is incorporated by reference herein in its entirety. When configured, the DRX functionality controls the expected UE behavior in terms of reception and processing of transmissions. Broadly speaking, the DRX functionality defines the notion of Active Time (also referred to as Active Time state or ACTIVE state), in which the UE is expected to received and process incoming transmissions as appropriate. For example, the UE is expected to decode the downlink (DL) control channels, and process grants, etc.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

SI. DRX has impacts on the resource selection in case of sidelink resource allocation Mode 2. In particular, it is desirable to select the resources for data transmission within the DRX Active Time of the intended RX UE(s) of the data, so that the selected resources are fully utilized. If not, the TX (transmitting) UF might risk selecting some resources which are not in the Active Time of intended RX (receiving) UE(s) so the resources are not at all usable for data transmission.

While it is clear that the resource identification procedure in the TX UE needs to consider the DRX Active Time of potential RX UEs, it is not clear which step in the selection procedure (see the four steps presented in above) is most suitable for that purpose and how the consideration of DRX Active Time should be done. In other words, an open question is how the TX UE uses the information about DRX Active Time of potential RX UEs to maximize the utility of a SL grant. Therefore, it is necessary to study the question and develop corresponding solutions.

In a first aspect of the disclosure, there is provided a method performed by a transmitting (TX) UE. The method comprises obtaining at least one Discontinuous Reception (DRX) active time of at least one receiving (RX) UE. The method further comprises selecting one or more resources to create a sidelink (SL) grant based on the at least one DRX active time of the at least one RX UE. The method further comprises selecting a destination based on the at least one DRX active time of at least one RX UE and at least one resource in a created SL grant. A destination is associated with a single or multiple RX UEs. Selecting one or more resources to create a SL grant based on the at least one DRX active time of the at least one RX UE comprises: determining whether one or more available resources for creating the SL grant for data transmission fulfills at least one first condition, and selecting the one or more resources for creating a SL grant for data transmission from the one or more available resources identified by a resource identification procedure, based on the at least one DRX active time of the at least one RX UE. The at least one first condition comprises: an overlapping in a time domain occurs between the at least one DRX active time of at least one RX UE and the one or more available resources identified by a resource identification procedure.

In an embodiment, obtaining at least one DRX active time of the at least one RX UE comprises selecting at least one DRX active time of at least one RX UE based on a selection rule.

In an embodiment, the transmitting UE has data in at least one logical channel, LCH, or a medium access control (MAC) control element (CE) to be transmitted to the at least one RX UE at a time of a resource selection trigger.

In an embodiment, the selection rule comprises selecting one or more DRX active time of one or more receiving UEs associated with a single destination among the at least one RX UE. One or more receiving UEs associated with the single destination have active time overlapping with one or more DRX active time of one or more receiving UEs associated with a largest number of other destinations in at least one RX UE.

In an embodiment, the selection rule comprises selecting one or more DRX active time of one or more receiving UEs associated with K destinations among the at least one RX UE. The K destinations are the first K destinations ranked in a descending order of a number of other destinations having overlapping Active Time with. A value of K can be configured or preconfigured or predefined.

In an embodiment, the selection rule comprises selecting one or more DRX active time of one or more receiving UEs associated with a single destination among the at least one RX UE. The single destination is associated with a SL LCH of a highest priority.

In an embodiment, the selection rule comprises selecting one or more DRX active time of one or more receiving UEs associated with two or more destinations among the at least one RX JE.

In an embodiment, the selection rule comprises selecting one or more DRX active time of one or more receiving UEs associated with a single destination among the at least one RX UE. The single destination has a highest number of associated receiving UEs.

In an embodiment, the selection rule comprises selecting one or more DRX active time of one or more receiving UEs associated with one or more destinations among the at least one RX UE. The transmitting UE is expecting to have data and/or MAC CE to transmit to the one or more destinations within a time period.

In an embodiment, the selection rule comprises selecting one or more DRX active time of one or more receiving UEs associated with a single destination among the at least one RX UE. The single destination is associated with a relay UE and at least one SL LCH carrying Uu traffic has a priority higher than a threshold.

In an embodiment, the selection rule comprises selecting one or more DRX active time of one or more receiving UEs associated with a single destination among the at least one RX UE. The single destination is associated with a remote UE and at least one SL LCH carrying Uu traffic has a priority higher than a threshold.

In an embodiment, the selection rule comprises selecting one or more DRX active time of one or more receiving UEs associated with one or more destinations among at least one RX UE. At least one receiving UE associated with the one or more destinations is within a predefined distance to the transmitting UE.

In an embodiment, the selection rule comprises selecting one or more DRX active time of one or more receiving UEs associated with a single destination among the at least one RX UE. The transmitting UE contains largest data volume in buffer or contains data volume above a threshold to be transmitted to the single destination.

In an embodiment, the selection rule comprises selecting one or more DRX active time of one or more receiving UEs associated with a single destination among the at least one RX UE. The transmitting UE contains data or MAC CE to be transmitted to the single destination which is delay critical or whose queuing delay is above a threshold.

In an embodiment, the selection rule comprises selecting one or more DRX active time of one or more receiving UEs associated with a single destination among the at least one RX UE. One or more receiving UEs associated with the single destination is associated with a given UE capability or UE category.

In an embodiment, the selection rule comprises selecting one or more DRX active time of one or more receiving UEs associated with a single destination among the at least one RX UE. The one or more receiving UEs associated with the single destination has a highest remaining battery life or remaining battery life above a threshold.

In an embodiment, the selection rule comprises selecting one or more DRX active time of one or more receiving UEs associated with a single destination among the at least one RX UE. The one or more receiving UEs associated with the single destination has a highest measured radio channel quality towards the transmitting UE.

In an embodiment, the selection rule comprises selecting one or more DRX active time of one or more receiving UEs associated with a single destination among the at least one RX UE. One or more receiving UEs associated with the single destination has a shortest active time intersected with the resource selection window.

In an embodiment, the selection rule comprises selecting one or more DRX active time of one or more receiving UEs associated with a single destination among the at least one RX UE. One or more receiving UEs associated with the single destination has a longest active time intersected with the resource selection window.

In an embodiment, selecting one or more resources to create a SL grant based on the at least one DRX active time of the at least one RX UE comprises identifying one or more available resources for creating a SL grant for data transmission based on one or more resources identified by a resource identification procedure and the at least one DRX active time of the at least one RX UE.

In an embodiment, identifying one or more available resources for creating a SL grant for data transmission based on one or more resources identified by a resource identification procedure and the at least one DRX active time of the at least one RX UE comprises finding one or more candidate resources by intersecting the at least one DRX active time of at least one RX UE with a resource selection window and identifying one or more available resources based on the one or more candidate resources.

In an embodiment, the method further comprises determining whether the one or more available resources for creating the SL grant for data transmission fulfills at least one second condition.

In an embodiment, the method further comprises triggering a new resource identification procedure based on the at least one DRX active time of at least one RX UE when none of the at least one first condition is fulfilled.

In an embodiment, the at least one first condition further comprises at least one of an overlapping in a time domain between one or more DRX active time of one or more receiving UEs associated with a destination and the one or more resources identified by a resource identification procedure exceeds a certain threshold, or an overlapping in a time domain between one or more DRX active time of one or more receiving UEs associated with a destination and the one or more resources identified by a resource identification procedure has at least a predefined number of slots belonging to a Discontinuous Reception (DRX) Timer.

In an embodiment, the at least one second condition comprises at least one of
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

In an embodiment, the selected destination fulfills at least one of:
the active time of one or more receiving UEs associated with the selected destination contains all resources in the created SL grant,
the active time of one or more receiving UEs associated with the destination contains a largest number of resources in the created SL grant, or
the active time of one or more receiving UEs associated with the destination contains at least a threshold number of resources in the created SL grant.

In an embodiment, the selected destination further fulfills at least one of:
the transmitting UE contains LCH with a highest priority to the destination,
the transmitting UE has a highest number of LCHs with available data to the destination,
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

In an embodiment, the method further comprises transmitting data to a destination using one or more resources in the created SL grant.

In an embodiment, the transmitting UE is a relay UE or a remote UE.

In a second aspect of the disclosure, there is provided a method performed by a receiving user equipment (RX) UE. The method comprises receiving data in a SL grant from a transmitting (TX) UE. One or more resources is selected to create a SL grant based on the at least one DRX active time of at least one RX UE. A destination is selected based on the at least one DRX active time of at least one RX UE associated with the destination, and at least one resource in the created SL grant. A destination is associated with a single or multiple RX UEs. One or more resources is selected to create a SL grant based on the at least one DRX active time of at least one RX UE comprises: whether one or more available resources for creating the SL grant for data transmission fulfills at least one first condition is determined, the one or more resources is selected for creating a SL grant for data transmission from the one or more available resources identified by a resource identification procedure, based on the at least one DRX active time of the at least one RX UE. The at least one first condition comprises: an overlapping in a time domain occurs between the at least one DRX active time of at least one RX UE and the one or more available resources identified by a resource identification procedure.

In an embodiment, the at least one DRX active time of at least one RX UE is selected based on a selection rule.

In an embodiment, the transmitting UE has data in at least one logical channel (LCH) or a medium access control (MAC) control element (CE) to be transmitted to the at least one RX UE at a time of a resource selection trigger.

In an embodiment, the selection rule comprises at least one of:
selecting one or more DRX active time of one or more receiving UEs associated with a single destination among the at least one RX UE. One or more receiving UEs associated with the single destination have active time overlapping with one or more DRX active time of one or more receiving UEs associated with a largest number of other destinations in at least one RX UE,
selecting one or more DRX active time of one or more receiving UEs associated with K destinations among the at least one RX UE. The K destinations are the first K destinations ranked in a descending order of a number of other destinations having overlapping Active Time with, and a value of K can be configured or preconfigured or predefined,
selecting one or more DRX active time of one or more receiving UEs associated with a single destination among the at least one RX UE. The single destination is associated with a SL LCH of a highest priority,
selecting one or more DRX active time of one or more receiving UEs associated with N destinations. The N destinations is selected according to a number of other destinations with which there are overlapped active time or according to highest SL LCH priority associated with a destination or randomly selected,
selecting one or more DRX active time of one or more receiving UEs associated with a single destination among the at least one RX UE. The single destination has a highest number of associated receiving UEs;
selecting one or more DRX active time of one or more receiving UEs associated with one or more destinations among the at least one RX UE. The transmitting UE is expecting to have data and/or MAC CE to transmit to the one or more destinations within a time period,
selecting one or more DRX active time of one or more receiving UEs associated with a single destination among the at least one RX UE. The single destination is associated with a relay UE and at least one SL LCH carrying Uu traffic has a priority higher than a threshold,
selecting one or more DRX active time of one or more receiving UEs associated with a single destination among the at least one RX UE. The single destination is associated with a remote UE and at least one SL LCH carrying Uu traffic has a priority higher than a threshold,
selecting one or more DRX active time of one or more receiving UEs associated with one or more destinations among at least one RX UE. At least one receiving UE associated with the one or more destinations is within a predefined distance to the transmitting UE,
selecting one or more DRX active time of one or more receiving UEs associated with a single destination among the at least one RX UE. The transmitting UE contains largest data volume in buffer or contains data volume above a threshold to be transmitted to the single destination,
selecting one or more DRX active time of one or more receiving UEs associated with a single destination among the at least one RX UE. The transmitting UE contains data or MAC CE to be transmitted to the single destination which is delay critical or whose queuing delay is above a threshold.
selecting one or more DRX active time of one or more receiving UEs associated with a single destination among the at least one RX UE. One or more receiving UEs associated with the single destination is associated with a given UE capability or UE category,
selecting one or more DRX active time of one or more receiving UEs associated with a single destination among the at least one RX UE. The one or more receiving UEs associated with the single destination has a highest remaining battery life or remaining battery life above a threshold,
selecting one or more DRX active time of one or more receiving UEs associated with a single destination among the at least one RX UE. The one or more receiving UEs associated with the single destination has a highest measured radio channel quality towards the transmitting UE,
selecting one or more DRX active time of one or more receiving UEs associated with a single destination among the at least one RX UE. One or more receiving UEs associated with the single destination has a shortest active time intersected with the resource selection window, or
selecting one or more DRX active time of one or more receiving UEs associated with a single destination among the at least one RX UE. One or more receiving UEs associated with the single destination has a longest active time intersected with the resource selection window.

In an embodiment, one or more available resources for creating a SL grant for data transmission is identified based on one or more resources identified by a resource identification procedure and the at least one DRX active time of the at least one RX UE

In an embodiment, one or more available resources for creating a SL grant for data transmission is identified by finding one or more candidate resources by intersecting the at least one DRX active time of at least one RX UE with a resource selection window and identifying one or more available resources based on the one or more candidate resources.

In an embodiment, the method further comprises whether the one or more available resources for creating the SL grant for data transmission fulfills at least one second condition is determined.

In an embodiment, a new resource identification procedure is triggered based on the at least one DRX active time of at least one RX UE when none of the at least one first condition is fulfilled.

In an embodiment, the at least one first condition further comprises at least one of:
an overlapping in a time domain between one or more DRX active time of one or more receiving UEs associated with a destination and the one or more resources identified by a resource identification procedure exceeds a certain threshold, or an overlapping in a time domain between one or more DRX active time of one or more receiving UEs associated with a destination and the one or more resources identified by a resource identification procedure has at least a predefined number of slots belonging to a Discontinuous Reception (DRX) Timer.

In an embodiment, the at least one second condition comprises at least one of:
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
ne or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

In an embodiment, the selected destination fulfills at least one of:
the active time of one or more receiving UEs associated with the selected destination contains all resources in the created SL grant,
the active time of one or more receiving UEs associated with the destination contains a largest number of resources in the created SL grant, or
the active time of one or more receiving UEs associated with the destination contains at least a threshold number of resources in the created SL grant.

In an embodiment, the selected destination further fulfills at least one of:
the transmitting UE contains LCH with a highest priority to the destination,
the transmitting UE has a highest number of LCHs with available data to the destination,
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

In an embodiment, the receiving UE is a relay UE or a remote UE.

In a third aspect of the disclosure, there is provided a transmitting user equipment (TX UE). The TX UE comprises a processor and a memory coupled to the processor. Said memory contains instructions executable by said processor. Said transmitting UE is operative to obtain at least one Discontinuous Reception (DRX) active time of at least one receiving (RX) UE. Said transmitting UE is further operative to select one or more resources to create a sidelink, SL, grant based on the at least one DRX active time of the at least one RX UE. Said transmitting UE is further operative to select a destination based on the at least one DRX active time of at least one RX UE and at least one resource in a created SL grant. A destination is associated with a single or multiple RX UEs. Select one or more resources to create a SL grant based on the at least one DRX active time of the at least one RX UE comprises: determine whether one or more available resources for creating the SL grant for data transmission fulfills at least one first condition. The at least one first condition comprises: an overlapping in a time domain occurs between the at least one DRX active time of at least one RX UE and the one or more available resources identified by a resource identification procedure. Select one or more resources to create a SL grant based on the at least one DRX active time of the at least one RX UE further comprises: select the one or more resources for creating a SL grant for data transmission from the one or more available resources identified by a resource identification procedure, based on the at least one DRX active time of the at least one RX UE.

In a fourth aspect of the disclosure, there is provided a receiving user equipment (RX UE). The RX UE comprises a processor and a memory coupled to the processor. Said memory contains instructions executable by said processor. Said receiving UE is operative to receive data in a SL grant from a transmitting (TX) UE. One or more resources is selected to create a SL grant based on the at least one DRX active time of at least one RX UE. A destination is selected based on the at least one DRX active time of at least one RX UE associated with the destination, and at least one resource in the created SL grant. A destination is associated with a single or multiple RX UEs. One or more resources is selected to create a SL grant based on the at least one DRX active time of at least one RX UE comprises: whether one or more available resources for creating the SL grant for data transmission fulfills at least one first condition is determined, the one or more resources is selected for creating a SL grant for data transmission from the one or more available resources identified by a resource identification procedure, based on the at least one DRX active time of the at least one RX UE. The at least one first condition comprises: an overlapping in a time domain occurs between the at least one DRX active time of at least one RX UE and the one or more available resources identified by a resource identification procedure.

In a fifth aspect of the disclosure, there is provided a transmitting UE. The transmitting UE comprises an obtaining module configured to obtain at least one Discontinuous Reception (DRX) active time of at least one receiving (RX) UE. The transmitting UE comprises a first selecting module configured to select one or more resources to create a sidelink (SL) grant based on the at least one DRX active time of the at least one RX UE. The transmitting UE comprises a second selecting module configured to select a destination based on the at least one DRX active time of at least one RX UE and at least one resource in a created SL grant. A destination is associated with a single or multiple RX UEs. The first selecting module is further configured to determine whether one or more available resources for creating the SL grant for data transmission fulfills at least one first condition. The at least one first condition comprises: an overlapping in a time domain occurs between the at least one DRX active time of at least one RX UE and the one or more available resources identified by a resource identification procedure. The first selecting module is further configured to select the one or more resources for creating a SL grant for data transmission from the one or more available resources identified by a resource identification procedure, based on the at least one DRX active time of the at least one RX UE.

In an embodiment, the transmitting UE may further comprise a determining module configured to determine whether the one or more available resources for creating the SL grant for data transmission fulfills at least one second condition.

In an embodiment, the transmitting UE may further comprise a triggering module configured to trigger a new resource identification procedure based on the at least one DRX active time of at least one RX UE when none of the at least one first condition is fulfilled.

In an embodiment, the transmitting UE may further comprise a transmitting module configured to transmitting data to a destination using one or more resources in the created SL grant.

In a sixth aspect of the disclosure, there is provided a receiving UE. The receiving UE comprises a receiving module. The receiving module may be configured to receive data in a SL grant from a transmitting (TX) UE. One or more resources is selected to create a SL grant based on the at least one DRX active time of at least one RX UE. A destination is selected based on the at least one DRX active time of at least one RX UE associated with the destination, and at least one resource in the created SL grant. A destination is associated with a single or multiple RX UEs. One or more resources is selected to create a SL grant based on the at least one DRX active time of at least one RX UE comprises: whether one or more available resources for creating the SL grant for data transmission fulfills at least one first condition is determined, the one or more resources is selected for creating a SL grant for data transmission from the one or more available resources identified by a resource identification procedure, based on the at least one DRX active time of the at least one RX UE. The at least one first condition comprises: an overlapping in a time domain occurs between the at least one DRX active time of at least one RX UE and the one or more available resources identified by a resource identification procedure.

In another aspect of the disclosure, there is provided a computer program product comprising instructions which when executed by at least one processor, cause the at least one processor to perform the method according to any one of the first and second aspects.

In another aspect of the disclosure, there is provided a computer-readable storage medium storing instructions which when executed by at least one processor, cause the at least one processor to perform the method according to any one of the first and second aspects.

In another aspect of the disclosure, there is provided a communication system including a host computer. The host computer includes processing circuitry configured to provide user data and a communication interface configured to forward the user data to a cellular network for transmission to a terminal device. The cellular network includes the network device and/or the terminal device (such as the transmitting UE and the receiving UE) above mentioned.

In embodiments of the present disclosure, the system further includes the terminal device. The terminal device is configured to communicate with the network device.

In embodiments of the present disclosure, the processing circuitry of the host computer is configured to execute a host application, thereby providing the user data; and the terminal device includes processing circuitry configured to execute a client application associated with the host application.

In another aspect of the disclosure, there is provided a communication system including a host computer and a network device. The host computer includes a communication interface configured to receive user data originating from a transmission from a terminal device. The transmission is from the terminal device to the network device. The terminal device is above mentioned.

In embodiments of the present disclosure, the processing circuitry of the host computer is configured to execute a host application. The terminal device is configured to execute a client application associated with the host application, thereby providing the user data to be received by the host computer.

In another aspect of the disclosure, there is provided a method implemented in a communication system which may include a host computer, a network device and a terminal device. The method may comprise providing user data at the host computer. Optionally, the method may comprise, at the host computer, initiating a transmission carrying the user data to the terminal device via a cellular network comprising the network device.

In another aspect of the disclosure, there is provided a communication system including a host computer. The host computer may comprise processing circuitry configured to provide user data, and a communication interface configured to forward the user data to a cellular network for transmission to a terminal device. The cellular network may comprise a network device having a radio interface and processing circuitry.

In another aspect of the disclosure, there is provided a method implemented in a communication system which may include a host computer, a network device and a terminal device. The method may comprise providing user data at the host computer. Optionally, the method may comprise, at the host computer, initiating a transmission carrying the user data to the terminal device via a cellular network comprising the network device. The terminal device may perform any step of the method according to the first and second aspects of the present disclosure.

In another aspect of the disclosure, there is provided a communication system including a host computer. The host computer may comprise processing circuitry configured to provide user data, and a communication interface configured to forward user data to a cellular network for transmission to a terminal device. The terminal device may comprise a radio interface and processing circuitry. The terminal device's processing circuitry may be configured to perform any step of the method according to the first and second aspects of the present disclosure.

In another aspect of the disclosure, there is provided a method implemented in a communication system which may include a host computer, a network device and a terminal device. The method may comprise, at the host computer, receiving user data transmitted to the network device from the terminal device which may perform any step of the method according to the first and second aspects of the present disclosure.

In another aspect of the disclosure, there is provided a communication system including a host computer. The host computer may comprise a communication interface configured to receive user data originating from a transmission from a terminal device to a network device. The terminal device may comprise a radio interface and processing circuitry. The terminal device's processing circuitry may be configured to perform any step of the method according to the first and second aspects of the present disclosure.

In another aspect of the disclosure, there is provided a method implemented in a communication system which may include a host computer, a network device and a terminal device. The method may comprise, at the host computer, receiving, from the network device, user data originating from a transmission which the network device has received from the terminal device.

In another aspect of the disclosure, there is provided a communication system which may include a host computer. The host computer may comprise a communication interface configured to receive user data originating from a transmission from a terminal device to a network device. The network device may comprise a radio interface and processing circuitry.

Embodiments herein may provide many advantages, of which a non-exhaustive list of examples follows. In some embodiments herein. The proposed solutions can maximize the utility of a SL grant under the condition that one or more RX UEs corresponding to TX UE is operating under DRX. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a illustrates a protocol stack for user plane transport, related to a PDU Session, including a Layer 2 UE-to-Network Relay UE;

FIG. 1b illustrates a protocol stack of the NAS connection for the Remote UE to the NAS-MM and NAS-SM components;

FIG. 2a schematically shows a high level architecture in the fifth generation network according to an embodiment of the present disclosure;

FIG. 2b schematically shows system architecture in a 4G network according to an embodiment of the present disclosure;

FIG. 2c shows a legacy resource selection procedure at a UE according to an embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 3e shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 5 shows a flowchart of a method according to another embodiment of the present disclosure;

FIG. 6 shows a flowchart of a method according to another embodiment of the present disclosure;

FIG. 7 is a block diagram showing an apparatus suitable for practicing some embodiments of the disclosure;

FIG. 8a is a block diagram showing a transmitting UE according to an embodiment of the disclosure;

FIG. 8b is a block diagram showing a receiving UE according to an embodiment of the disclosure;

FIG. 9 is a schematic showing a wireless network in accordance with some embodiments;

FIG. 10 is a schematic showing a user equipment in accordance with some embodiments;

FIG. 11 is a schematic showing a virtualization environment in accordance with some embodiments:

FIG. 12 is a schematic showing a telecommunication network connected via an intermediate network to a host computer in accordance with some embodiments;

FIG. 13 is a schematic showing a host computer communicating via a base station with a user equipment over a partially wireless connection in accordance with some embodiments;

FIG. 14 is a schematic showing methods implemented in a communication system including a host computer, a base station and a user equipment in accordance with some embodiments;

FIG. 15 is a schematic showing methods implemented in a communication system including a host computer, a base station and a user equipment in accordance with some embodiments;

FIG. 16 is a schematic showing methods implemented in a communication system including a host computer, a base station and a user equipment in accordance with some embodiments; and

FIG. 17 is a schematic showing methods implemented in a communication system including a host computer, a base station and a user equipment in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G. 5G communication protocols, and/or any other protocols either currently known or to be developed in the future. The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network). SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The network device may be an access network device with accessing function in a communication network via which a terminal device accesses to the network and receives services therefrom. The access network device may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the access network device comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment.” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”. “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

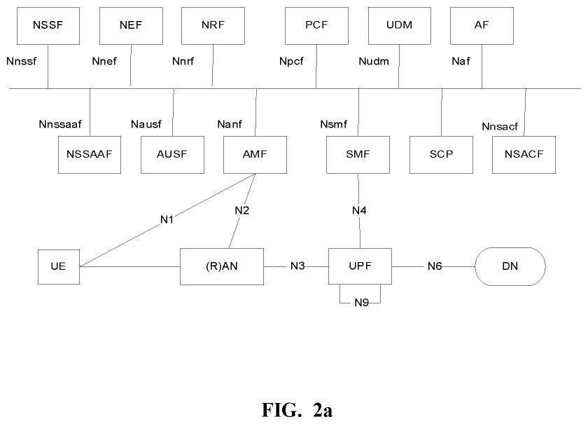

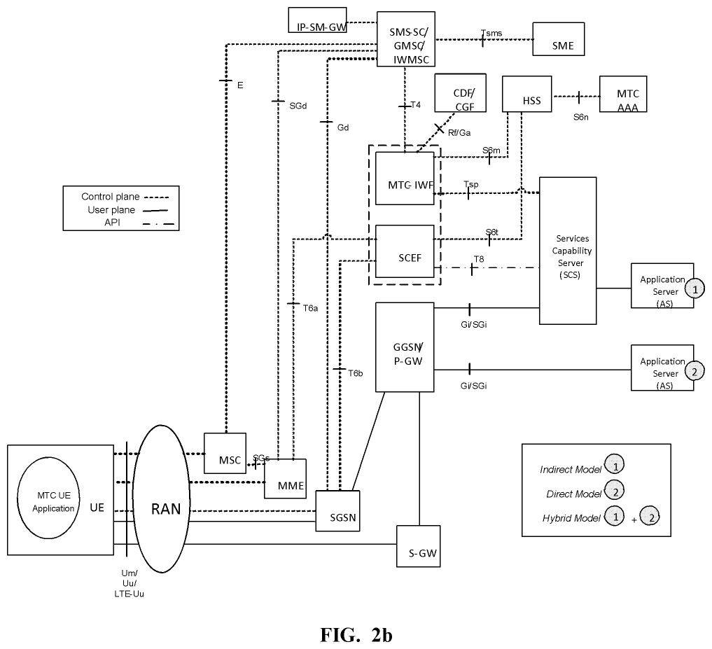

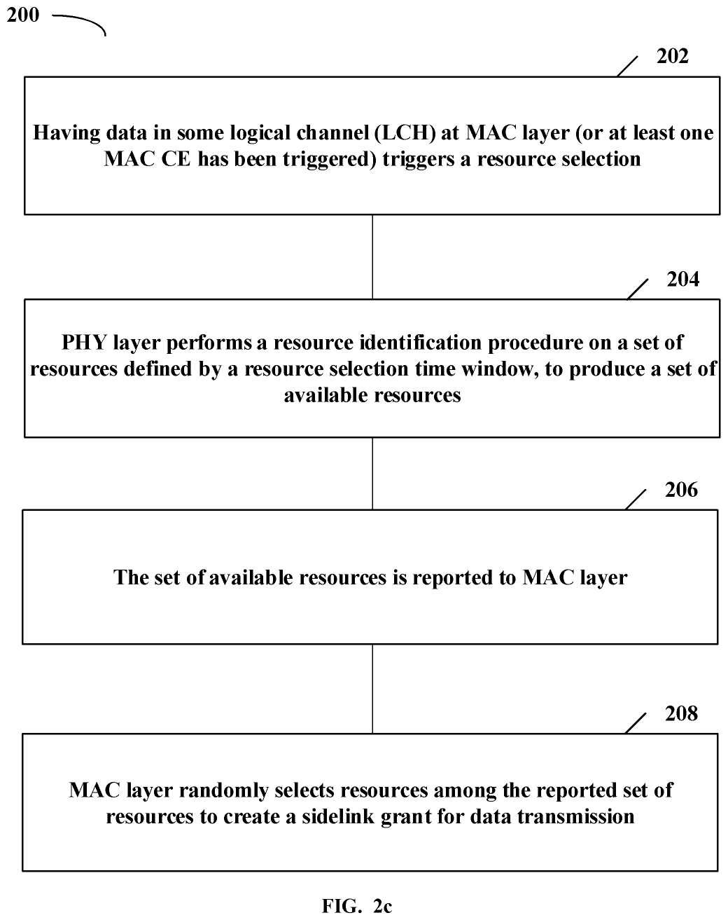

Although the subject matter described herein may be implemented in any appropriate type of system using any suitable components, the embodiments disclosed herein are described in relation to a communication system complied with the exemplary system architectures illustrated in FIGS. 2a-2b. For simplicity, the system architectures of FIGS. 2a-2b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

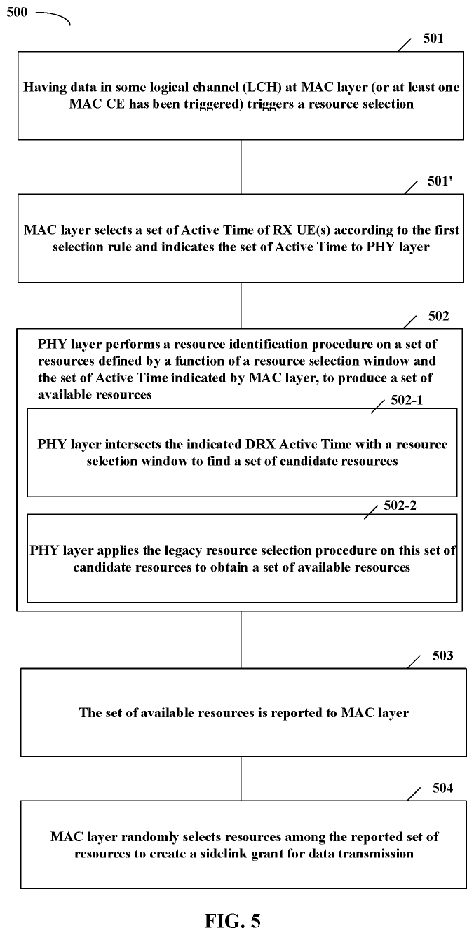

FIG. 2a schematically shows a high level architecture in the fifth generation network according to an embodiment of the present disclosure. For example, the fifth generation network may be 5GS. The architecture of FIG. 2a is same as FIG. 4.2.3-1 as described in 3GPP TS 23.501 V17.0.0, the disclosure of which is incorporated by reference herein in its entirety. The system architecture of FIG. 2a may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2a, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 2a also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2a may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.0.0.

FIG. 2b schematically shows system architecture in a 4G network according to an embodiment of the present disclosure, which is the same as FIG. 4.2-1a of 3GPP TS 23.682 V16.9.0, the disclosure of which is incorporated by reference herein in its entirety. The system architecture of FIG. 2b may comprise some exemplary elements such as Services Capability Server (SCS), Application Server (AS), SCEF (Service Capability Exposure Function), HSS, UE, RAN (Radio Access Network), SGSN (Serving GPRS (General Packet Radio Service) Support Node), MME, MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 2b may be same as the corresponding network elements and interfaces as described in 3GPP TS 23.682 V16.9.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 2b, the exemplary system architecture also contains various reference points.

Tsms: Reference point used by an entity outside the 3GPP network to communicate with UEs used for MTC via SMS (Short Message Service).

Tsp: Reference point used by a SCS to communicate with the MTC-IWF related control plane signaling.

T4: Reference point used between MTC-IWF and the SMS-SC in the HPLMN.

T6a: Reference point used between SCEF and serving MME.

T6b: Reference point used between SCEF and serving SGSN.

T8: Reference point used between the SCEF and the SCS/AS.

Som: Reference point used by MTC-IWF to interrogate HSS/HLR (Home Location Register).

Son: Reference point used by MTC-AAA to interrogate HSS/HLR.

S6t: Reference point used between SCEF and HSS.

SGs: Reference point used between MSC and MME.

Gi/SGi: Reference point used between GGSN/P-GW and application server and between GGSN/P-GW and SCS.

Rf/Ga: Reference point used between MTC-IWF and CDF/CGF.

Gd: Reference point used between SMS-SC/GMSC/IWMSC and SGSN.

SGd: Reference point used between SMS-SC/GMSC/IWMSC and MME.

E: Reference point used between SMS-SC/GMSC/IWMSC and MSC.

The end-to-end communications, between the MTC Application in the UE and the MTC Application in the external network, uses services provided by the 3GPP system, and optionally services provided by a Services Capability Server (SCS).

The MTC Application in the external network is typically hosted by an Application Server (AS) and may make use of an SCS for additional value added services. The 3GPP system provides transport, subscriber management and other communication services including various architectural enhancements motivated by, but not restricted to, MTC (e.g. control plane device triggering).

Different models are foreseen for machine type of traffic in what relates to the communication between the AS and the 3GPP system and based on the provider of the SCS. The different architectural models that are supported by the Architectural Reference Model include the Direct Model, Indirect Model and Hybrid Model as described in 3GPP TS 23.682 V16.9.0.

The embodiments of the present disclosure are described in the context of 3GPP sidelink, where UEs operating using SL communicate directly with each other, without sending the information through the base station.

The embodiments of the present disclosure are focus on 3GPP technology (NR SL) and terminology. Nevertheless, most of the embodiments are applicable to any kind of device-to-device (D2D) communications with respect to sensing operations and discontinuous reception (DRX).

The term “resource selection” is used for both resource selection and resource reselection. Active Time denotes the DRX Active Time of one or more UEs, which is typically clear from the context.

The term “destination” is used to denote one or more UEs associated with a single destination ID (identifier) (e.g., a MAC-layer ID). In case of unicast communication, typically a destination is associated with a single RX UE, while in the case of groupcast or broadcast, a destination can be associated with multiple RX UEs.

The embodiments of the present disclosure are concerned with the resource selection process performed by the TX UE, considering the TX UE's knowledge about the Active Time of the potential RX UEs. The TX UE can acquire the knowledge of the Active Time in various ways and the present disclosure has no limit on it.

In some embodiments of the disclosure, a RM UE is referred to as a remote UE that is able to transmit/receive packet from/to an access network device such as gNB via an intermediate terminal device (UE to NW relay UE) that we refer to as RL (relay) UE.

In some embodiments of the disclosure, the link or radio link over which the signals are transmitted between at least two UEs for D2D (device to device) operation is called herein as the sidelink (SL). The signals transmitted between the UEs for D2D operation are called herein as SL signals. The term SL may also interchangeably be called as D2D link, vehicle-to-everything (V2X) link, prose link, peer-to-peer link, PC5 link, etc. The SL signals may also interchangeably be called as V2X signals, D2D signals, prose signals, PC5 signals, peer-to-peer signals etc.

In some embodiments of the disclosure, the RM UE is assumed to be currently directly connected to the gNB or connected via a L2 RL UE, i.e., the RM UE is visible to both RAN and core NW (network).

Some embodiments of the disclosure are applicable to L2 based U2N (UE to network) relay scenarios.

As used herein, the term “Uu interface” may be referred to as the radio interface between a terminal device and a network device (such as base station, gNB, eNB, etc.). The term “PC5 interface” may be referred to as the radio interface between any two terminal devices.

### 3GPP Work on Sidelink

3GPP specified support in LTE for proximity services (ProSe) in Releases (ReL) 12 and 13, targeting public safety use cases (e.g., first responders) as well as a small subset of commercial use cases (e.g., discovery). The main novelty of ProSe was the introduction of device-to-device (D2D) communications using the sidelink (SL) interface. During Rel-14 and Rel-15 in 3GPP, major changes were introduced to the LTE SL framework with the aim of supporting V2X (vehicle-to-everything or vehicle-to-anything) communications. V2Xcollectively denotes communication between vehicle to any other endpoint (e.g., a vehicle, a pedestrian, etc.). The feature targeted mostly basic V2X use cases such as day-1 safety, etc.

During 3GPP Rel-16, 3GPP worked on specifying the sidelink interface for the 5G New Radio (NR). The NR sidelink in Rel-16 mainly targets advanced V2X services, which can be categorized into four use case groups: vehicles platooning, extended sensors, advanced driving and remote driving. The advanced V2X services require a new sidelink in order to meet the stringent requirements in terms of latency and reliability. The NR sidelink is designed to provide higher system capacity and better coverage, and to allow for an easy extension to support the future development of further advanced V2X services and other related services.

Given the targeted V2X services by NR sidelink, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest to the members of the platoon, making the members of the platoon a natural groupcast. In another example, the see-through use case most likely involves only a pair of vehicles, for which unicast transmissions naturally fit. Therefore, NR sidelink not only supports broadcast as in LTE sidelink, but also groupcast and unicast transmissions. Like in LTE sidelink, the NR sidelink is designed in such a way that its operation is possible with and without network coverage and with varying degrees of interaction between the UEs (user equipment) and the NW (network), including support for standalone, network-less operation.

In 3GPP Rel-17, 3GPP is working on multiple enhancements for the sidelink with the aim of extending the support for V2X and to cover other use cases (UCs) such as public safety (see 3GPP TSG RAN Meeting #86 RP-193231, Sitges, Spain, Dec. 9-12, 2019, the disclosure of which is incorporated by reference herein in its entirety). Among these, improving the performance of power limited UEs (e.g., pedestrian UEs, first responder UEs, etc.) and improving the performance using resource coordination are considered critical.

### Resource Allocation for NR Sidelink Transmissions

There are two resource allocation modes for NR sidelink:

Network-based resource allocation, in which the network selects the resources and other transmit parameters used by sidelink UEs. In some cases, the network may control every single transmission parameter. In other cases, the network may select the resources used for transmission but may give the transmitter the freedom to select some of the transmission parameters, possibly with some restrictions. In the context of NR SL, 3GPP refers to this resource allocation mode as Mode 1.

Autonomous resource allocation, in which the UEs autonomously select the resources and other transmit parameters. In this mode, there may be no intervention by the network (e.g., out of coverage, unlicensed carriers without a network deployment, etc.) or very minimal intervention by the network (e.g., configuration of pools of resources, etc.). In the context of NR SL, 3GPP refers to this resource allocation mode as Mode 2.

Some embodiments of the disclosure are relevant to resource allocation Mode 2 in NR SL or any other mode in which the UE(s) perform resource selection on its own.

Mode 2 resource selection in NR SL involves both a MAC layer and a physical (PHY) layer. In a simplified term, the resource identification procedure works as follows:
Step 1: Having data in some logical channel (LCH) at MAC layer (or at least one MAC CE has been triggered) triggers a resource selection.
Step 2: PHY layer performs a resource identification procedure on a set of resources defined by a resource selection window, to produce a set of available/candidate resources.
Step 3: The set of available/candidate resources is reported to MAC layer.
Step 4: MAC layer randomly selects resources among the reported set of resources to create a sidelink grant for data transmission. In the specification, this is sometimes referred to as grant selection.

The above resource identification procedure is described in detail in Section 5.22.1 of 3GPP TS 38.321 V16.6.0 and Section 8.1.4 of 3GPP TS 38.214 V16.7.0, the disclosure of which is incorporated by reference herein in its entirety.

### Logical Channel Prioritization (LCP)

Once a SL grant is created, the MAC layer selects a destination and then selects data, which will be transmitted using the SL grant, from the logical channels associated with that destination. Such a process is called Logical Channel Prioritization and is specified in the MAC specification of 3GPP, see Section 5.22.1.4.1 in 3GPP TS 38.321 V16.6.0.

### Discontinuous Reception (DRX)

In cellular communications, DRX refers to mechanisms that allow a node (typically a UE) to turn off at least some parts of its receiver circuitry when no incoming data is expected, which helps reduce the power consumption of the node. For 5G NR, the DRX procedures are described in 3GPP TS 38.321 V16.6.0 and relevant parameters are described in 3GPP TS 38.331 V16.6.0, the disclosure of which is incorporated by reference herein in its entirety. When configured, the DRX functionality controls the expected UE behavior in terms of reception and processing of transmissions. Broadly speaking, the DRX functionality defines the notion of Active Time (also referred to as Active Time state or ACTIVE state), in which the UE is expected to receive and process incoming transmissions as appropriate. For example, the UE is expected to decode the downlink (DL) control channels, and process grants, etc.

It is noted the state of the DRX is not related to the RRC state of the UE. That is, even if the UE is in ACTIVE or INACTIVE, its RRC state is not changed (i.e., the UE it stays in its current RRC state-RRC CONNECTED/IDLE/INACTIVE).

When the UE is not in Active Time (in other words, the UE is in Inactive mode), there is no expectation on the UE receiving and processing transmissions. That is, the base station (BS) cannot assume that the UE will be listening to DL transmissions. The DRX configuration defines the transitions between states.

Typically. UEs that are not in Active Time turn off some of their components and enter a low-power (i.e., sleeping) mode. To ensure that the UE switches regularly to Active Time (i.e., wakes up), a DRX cycle is defined. This DRX cycle is controlled by two parameters:

The periodicity of the DRX cycle, which controls how frequently the UE switches to Active Time.

The duration of the Active Time, which controls for how long the UE is in active state.

In addition to this basic cycle, the DRX procedures also define other conditions that may allow the UE to switch between Active Time and Inactive Time. For example, if a UE is expecting a retransmission from the gNB (next generation NodeB), the UE may enter Inactive Time (i.e., while the gNB prepares the retransmission) and then may enter Active Time (i.e., during a window in which the gNB may send the transmission).

### DRX in Sidelink

In V2X, User Equipments (UEs) are typically mounted in a car and have no significant power restrictions. In contrast, National Security and Public Safety (NSPS) and Network Controlled Interactive Services (NCIS) mostly use handheld UEs, for which energy efficiency is a concern. With this in mind, the Rel. 17 Work Item on NR sidelink enhancements (see 3GPP TSG RAN Meeting #86 RP-193231) includes the study and specification of SL DRX mechanism as one of its objectives. This includes defining SL DRX configurations and the corresponding UE procedure, specifying mechanisms to align sidelink DRX configurations among the UEs communicating with each other, and specifying mechanisms to align sidelink DRX configurations with Uu DRX configurations for an in-coverage UE.

So far, the RAN (Radio Access Network) Working Group 2 of 3GPP has reached a number of agreements on the design of SL DRX. In general, as with DRX in the Uu, SL DRX also consists of a set of timers that define the Active Time (e.g., sl-drx-OnDuration, sl-DRXInactivityTimer. or sl-drx-RetransmissionTimer) and a set of timers that define the Inactive Time (e.g., SL HARQ (Hybrid Automatic Repeat Request) RTT (Round-Trip Time) timer). Among those, the sl-drx-OnDuration timer defines the Active duration in each DRX cycle. Details of each timer and the related procedures for each casting type (i.e., unicast, groupcast, broadcast) are under discussion.

Another important feature of SL DRX, which is also under development in 3GPP Rel-17, is mechanisms to align the Active Time of transmitter UE and the intended receiver UEs. This will help in maximizing the power-saving benefit of SL DRX.

### Layer 2 (L2) UE-to-Network Relay

In the 3GPP TR 23.752 V17.0.0 clause 6.7, the disclosure of which is incorporated by reference herein in its entirety, the layer-2 based UE-to-Network relay is described.

The protocol architecture supporting a L2 UE-to-Network Relay UE is provided. The L2 UE-to-Network Relay UE provides forwarding functionality that can relay any type of traffic over the PC5 link. The L2 UE-to-Network Relay UE provides the functionality to support connectivity to the 5GS (fifth generation system) for remote UEs. A UE is considered to be a remote UE if it has successfully established a PC5 link to the L2 UE-to-Network Relay UE. A remote UE can be located within NG-RAN (next generation radio access network) coverage or outside of NG-RAN coverage.

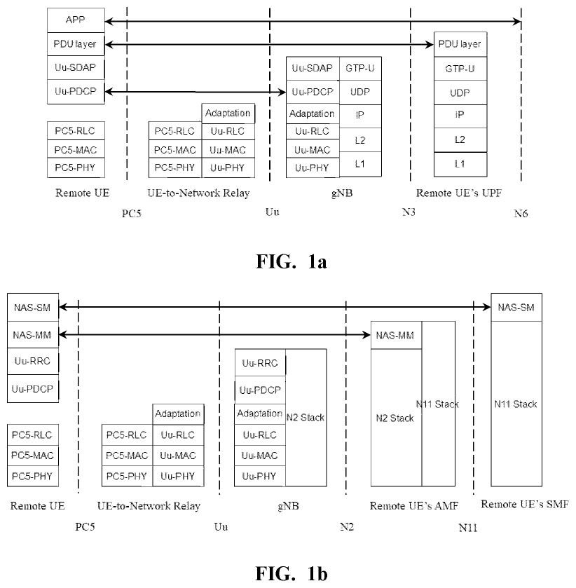

FIG. 1a illustrates a protocol stack for user plane transport, related to a PDU Session, including a Layer 2 UE-to-Network Relay UE, which is same as Figure A.2.1-1 of 3GPP TR 23.752 V17.0.0. APP denotes application. PDU denotes Protocol Data Unit. SDAP denotes Service Data Adaptation Protocol. RLC denotes Radio Link Control. MAC denotes Medium Access Control. PHY denotes physical. L2 denotes layer 2. The PDU (Protocol Data Unit) layer corresponds to the PDU carried between the Remote UE and the Data Network (DN) over the PDU session. It is important to note that the two endpoints of the PDCP (Packet Data Convergence Protocol) link are the Remote UE and the gNB. The relay function is performed below PDCP. This means that data security is ensured between the Remote UE and the gNB without exposing raw data at the UE-to-Network Relay UE.

The adaptation rely layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu.

FIG. 1b illustrates a protocol stack of the NAS (Non-Access-Statum) connection for the Remote UE to the NAS-MM and NAS-SM components, which is same as Figure A.2.2-1 of 3GPP TR 23.752 V17.0.0. NAS denotes Non-Access Stratum. SM denotes Session Management. MM denotes Mobility Management. The NAS messages are transparently transferred between the Remote UE and 5G-AN (access network) over the Layer 2 UE-to-Network Relay UE using:
PDCP end-to-end connection where the role of the UE-to-Network Relay UE is to relay the PDUs over the signaling radio bear without any modifications.
N2 connection between the 5G-AN and AMF (Access and mobility Function), over N2.
N3 connection AMF and SMF (Session Management Function) over N11.

The role of the UE-to-Network Relay UE is to relay the PDUs from the signaling radio bearer without any modifications.

FIG. 2c shows a legacy resource selection procedure at a UE according to an embodiment of the present disclosure. The legacy resource selection procedure may comprise four main steps as described above.

Step 202: Having data in some logical channel (LCH) at MAC layer (or at least one MAC CE has been triggered) triggers a resource selection.

Step 204: PHY layer performs a resource identification procedure on a set of resources defined by a resource selection time window, to produce a set of available resources.

Step 206: The set of available resources is reported to MAC layer.

Step 208: MAC layer randomly selects resources among the reported set of resources to create a sidelink grant for data transmission.

Note that, eventually, the sidelink grant is used to transmit data to a single destination (see the LCP described above). That is, the data intended for different destination IDs is not multiplexed in a single MAC PDU or transport block.

Based on these steps, this present disclosure proposes several solutions to the open question posed above, i.e., how to use the information about DRX Active time of potential RX UEs to maximize the utility of a SL grant. It is proposed three solutions to take into account the DRX Active Time of RX UEs.

The first solution is concerned with selecting a set of Active Time, i.e., it proposes rules to select a set of DRX Active Time that will be used to limit the resources that can be used to build a SL grant.

The second solution is concerned with selecting one or more resources, i.e., it proposes rules to select one or more resources to create a SL grant based on the DRX Active Time of RX UEs.

The third solution is concerned with selecting a destination whose data in the LCHs to become part of a MAC PDU, i.e., it proposes rules to select a destination whose data in the LCHs can be transmitted using a SL grant, taking into account the DRX Active Time of destinations.

The embodiments of the proposed solutions can be combined in various meaningful ways to benefit from their individual technical advantages.

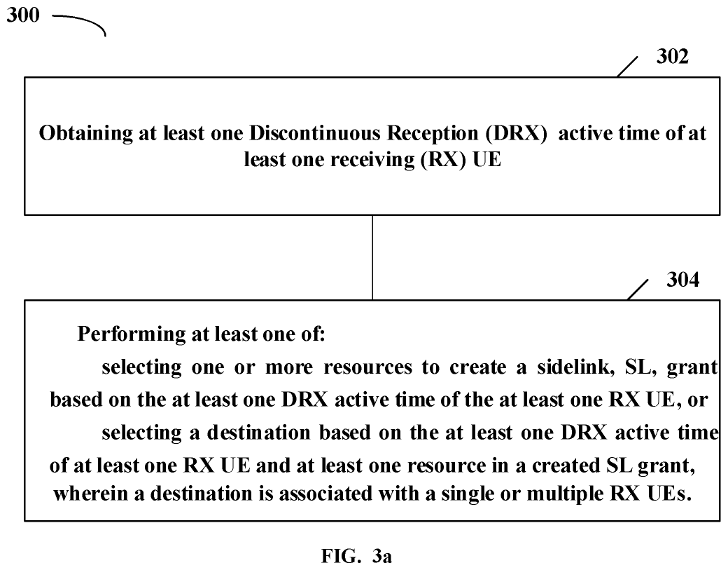

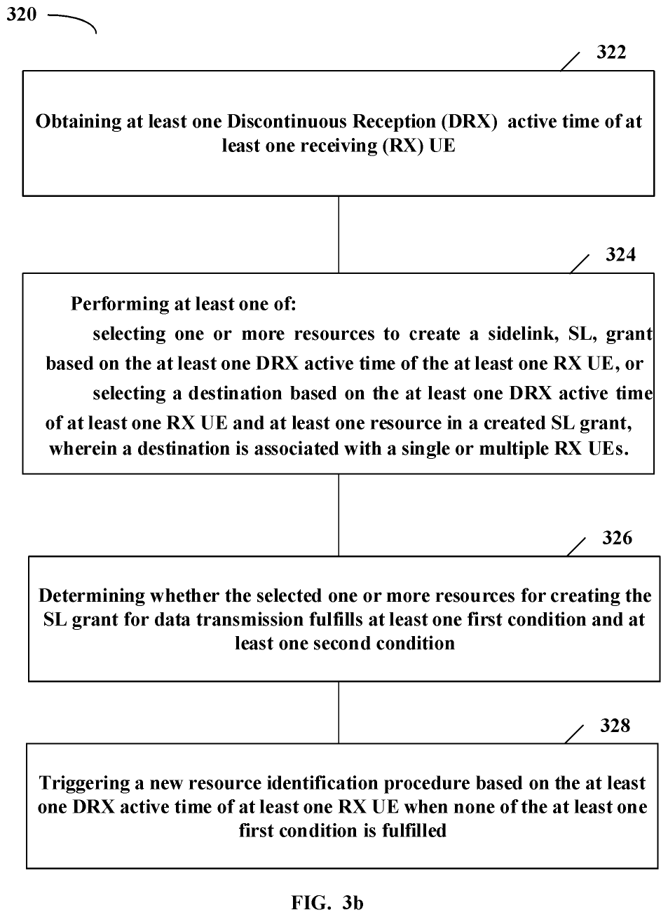

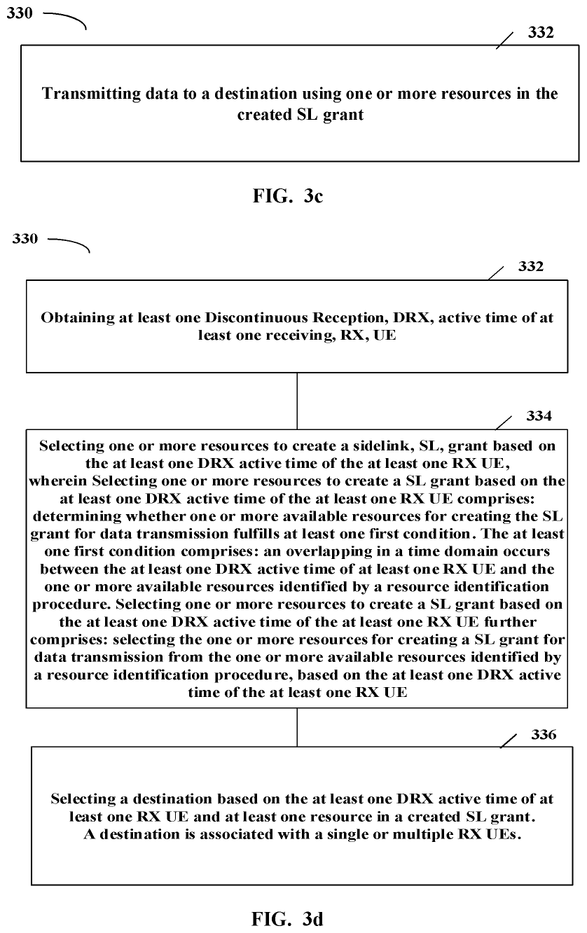

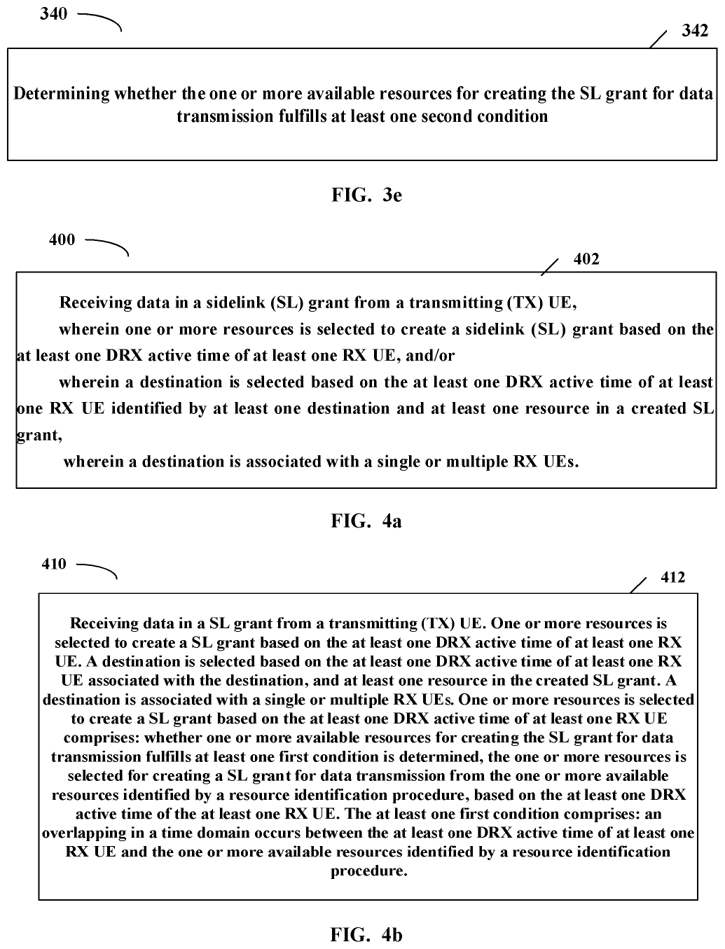

FIG. 3a shows a flowchart of a method according to an embodiment of the present disclosure, which may be performed by an apparatus implemented in or at or as a transmitting UE or communicatively coupled to the transmitting UE. As such, the apparatus may provide means or modules for accomplishing various parts of the method 300 as well as means or modules for accomplishing other processes in conjunction with other components.

The transmitting UE may be any suitable UE which requires to transmit data to a receiving UE over a SL link. In an embodiment, the transmitting UE may be a remote UE or a relay UE.

At block 302, the transmitting UE may obtain at least one Discontinuous Reception (DRX) active time of at least one receiving (RX) UE. A destination is associated with a single or multiple RX UEs. As described above, the term “destination” is used to denote one or more UEs associated with a single destination ID (identifier) (e.g., a MAC-layer ID). In case of unicast communication, typically a destination is associated with a single RX UE, while in the case of groupcast or broadcast, a destination can be associated with multiple RX UEs. The information of DRX active time may comprise the active time of each of at least one RX UE.

The transmitting UE may obtain the at least one DRX active time of at least one RX UE in various ways and the present disclosure has no limit on it. For example, the at least one DRX active time of at least one RX UE may be obtained from a network, such as from an access network node or a core network node. The at least one DRX active time of at least one RX UE may be obtained from an application. The at least one DRX active time of at least one RX UE may be obtained from the at least one RX UE.

In an embodiment, the transmitting UE may select at least one DRX active time of at least one RX UE based on a selection rule for example from the obtained at least one DRX active time of at least one RX UE. The selection rule may be any suitable selection rule. For example, the selection rule may be used to select a set of DRX Active Time that will be used to limit the resources that can be used to build a SL grant. The selection step may be performed between step 202 and step 204 of FIG. 2c, for example, the MAC layer of the transmitting UE may select at least one DRX active time of at least one RX UE according to the selection rule and indicates the at least one DRX active time of at least one RX UE to a PHY layer of the transmitting UE.

In an embodiment, the transmitting UE has data in at least one logical channel, LCH, or a medium access control (MAC) control element (CE) to be transmitted to the at least one RX UE at a time of a resource selection trigger.

In an embodiment, the selection rule comprises at least one of:
selecting one or more DRX active time of one or more receiving UEs associated with a single destination among the at least one RX UE. One or more receiving UEs associated with the single destination have active time overlapping with one or more DRX active time of one or more receiving UEs associated with a largest number of other destinations in at least one RX UE,
selecting one or more DRX active time of one or more receiving UEs associated with K destinations among the at least one RX UE. The K destinations are the first K destinations ranked in a descending order of a number of other destinations having overlapping Active Time with, and a value of K can be configured or preconfigured or predefined, selecting one or more DRX active time of one or more receiving UEs associated with a single destination among the at least one RX UE. The single destination is associated with a SL LCH of a highest priority,
selecting one or more DRX active time of one or more receiving UEs associated with N destinations. The N destinations is selected according to a number of other destinations with which there are overlapped active time or according to highest SL LCH priority associated with a destination or randomly selected;
selecting one or more DRX active time of one or more receiving UEs associated with a single destination among the at least one RX UE. The single destination has a highest number of associated receiving UEs;
selecting one or more DRX active time of one or more receiving UEs associated with one or more destinations among the at least one RX UE. The transmitting UE is expecting to have data and/or MAC CE to transmit to the one or more destinations within a time period,
selecting one or more DRX active time of one or more receiving UEs associated with a single destination among the at least one RX UE. The single destination is associated with a relay UE and at least one SL LCH carrying Uu traffic has a priority higher than a threshold,
selecting one or more DRX active time of one or more receiving UEs associated with a single destination among the at least one RX UE. The single destination is associated with a remote UE and at least one SL LCH carrying Uu traffic has a priority higher than a threshold,
selecting one or more DRX active time of one or more receiving UEs associated with one or more destinations among at least one RX UE. At least one receiving UE associated with the one or more destinations is within a predefined distance to the transmitting UE,
selecting one or more DRX active time of one or more receiving UEs associated with a single destination among the at least one RX UE. The transmitting UE contains largest data volume in buffer or contains data volume above a threshold to be transmitted to the single destination,
selecting one or more DRX active time of one or more receiving UEs associated with a single destination among the at least one RX UE. The transmitting UE contains data or MAC CE to be transmitted to the single destination which is delay critical or whose queuing delay is above a threshold,
selecting one or more DRX active time of one or more receiving UEs associated with a single destination among the at least one RX UE. One or more receiving UEs associated with the single destination is associated with a given UE capability or UE category,
selecting one or more DRX active time of one or more receiving UEs associated with a single destination among the at least one RX UE. The one or more receiving UEs associated with the single destination has a highest remaining battery life or remaining battery life above a threshold,
selecting one or more DRX active time of one or more receiving UEs associated with a single destination among the at least one RX UE. The one or more receiving UEs associated with the single destination has a highest measured radio channel quality towards the transmitting UE,
selecting one or more DRX active time of one or more receiving UEs associated with a single destination among the at least one RX UE. One or more receiving UEs associated with the single destination has a shortest active time intersected with the resource selection window, or
selecting one or more DRX active time of one or more receiving UEs associated with a single destination among the at least one RX UE. One or more receiving UEs associated with the single destination has a longest active time intersected with the resource selection window.

Example 1: the Active Time of a single destination among the at least one RX UE to which the transmitting UE has data in the SL LCHs to be transmitted is selected. The single destination has Active Time overlapping with the respective Active Time of the largest number of other destinations among the at least one RX UE to which the transmitting UE has data in the SL LCHs or MAC CE to be transmitted. The advantage of Example 1 is that it will maximize the possibility that a SL grant using these resources will be utilized because there are highest number of destinations sharing the selected Active Time.

Example 2: the same rule as in Example 1 but counting top K destinations among the at least one RX UE in terms of the number of other destinations with overlapping Active Time. K may take any suitable value and the present disclosure has not limit on it.

Example 3: the Active Time of a single destination among the at least one RX UE to which the transmitting UE has data in the SL LCHs or MAC CE to be transmitted is selected. The single destination is associated with a SL LCH of highest priority among the SL LCHs having data or a MAC CE being triggered at the time of the resource selection trigger. The advantage of Example 3 is that the set of resources selected before building the SL grant is optimized for transmissions to that single destination since resources outside the Active Time of that destination are excluded in the first place (before building a SL grant). This option works most efficiently when the UE is mainly interested in transmitting only data that are already available in the SL LCHs (i.e., not considering data that might be available in the SL LCHs after the resource selection trigger) and has clear criteria for selecting a destination given such the data.

Example 4: The overall Active Time of N destinations to which the transmitting UE has data in the SL LCHs or MAC CE to be transmitted at the time of the resource selection trigger is selected. N may take any suitable value and the present disclosure has not limit on it. For example. N may be an integer larger than 1 and smaller than or equal to the total number of destinations to which the transmitting UE has data in the SL LCHs or MAC CE to be transmitted at the time of the resource selection trigger. The difference compared to Example 3 is that resources useful for multiple destinations (who already have data in the SL LCHs) are considered before building the SL grant and the LCP, leaving the work of selecting a single destination to a later stage, e.g., the LCP. Therefore, compared to Example 3, the selected resources before building the SL grant are more likely usable to data that are available in the SL LCHs after resource selection trigger (see also Example 5 below). The N destinations may be selected according to rule in Example 1 (i.e., according to the number of other destinations with which there are overlapped active time) or Example 3 (i.e., according to highest SL LCH priority associated with the destination) or randomly selected.

Example 5: a single destination among the at least one RX UE to which the transmitting UE has data in the SL LCHs or MAC CE to be transmitted is selected. The destination has highest number of associated Rx UEs (note that a destination could be associated with a single Rx UE as in unicast, or with multiple Rx UEs as in groupcast/broadcast). This option aims at maximizing the number of Rx UEs receiving the messages.

Example 6: The overall Active Time of one or more destinations to which the UE is expecting to have data or MAC CE to transmit within a certain time period (although such data have not yet available in the SL LCHs at the time of resource selection trigger). The exact value or the upper limit of this time period can be (pre)-configured or up to UE implementation, taking into account UE's complexity. Examples of the data of this type include at least one of the following:
Data that is expected to arrive shortly due to the periodic nature of the data traffic source. E.g., there are messages that are generated by higher layer every x milliseconds (x may take any suitable value and the present disclosure has not limit on it) and based on the most recent arrival time of such messages, the UE expects that the next message is arriving soon.
Data that the UE is going to generate, in response to a previous message that the UE has received. For example, the UE has received a CSI (Channel State Information) report request from a peer UE and the UE is to transmit a CSI report message to the peer UE within a predefined time period after the request. Another example is that the UE has received a request for inter-UE coordination message and the UE is to send the coordination message within a predefined time period. Yet another example is that the UE has received a transmission or signaling from a peer UE, the UE needs to provide response or acknowledgement to the peer UE soon.

The advantage of the rule in Example 6 is that the selected resources before building the SL grant can be used for future data (i.e., data which arrive after the resource selection trigger and before the data transmission by the UE), which might have higher priority or more urgent to be transmitted than the data that are already available in the SL LCHs at the time of resource selection trigger.

Example 7: in the context of UE-to-network relaying and in case the Tx UE is a remote UE or a relay UE, the transmitting UE may select the Active Time of a destination associated with a relay UE or a remote UE if the highest priority of SL SL LCH(s) carrying Uu traffic is higher than a (pre) configured threshold.

Example 8: The Active Time of one or more destinations whose associated RX UEs are within a certain distance to the transmitting UE is selected. In this case, the transmitting UE aims at finding resources that are usable for transmission to the nearest peer UEs. Note that, as in Example 6, data for these peer UEs are not necessarily available in the SL LCHs at the time of resource selection trigger.

Example 9: in addition to any one of the above examples, the transmitting UE may consider at least one of the following conditions to select one or multiple destinations.
The transmitting UE contains largest data volume in buffer or contains data volume above a threshold to be transmitted to the single destination.
The transmitting UE contains data or MAC CE to be transmitted to the single destination which is delay critical, e.g., with lowest Packet Delay Budget (PDB), or whose queuing delay is above a threshold.
One or more receiving UEs associated with the single destination is associated with a given UE capability or UE category.
The one or more receiving UEs associated with the single destination has a highest remaining battery life or remaining battery life above a threshold.
The one or more receiving UEs associated with the single destination has a highest measured radio channel quality towards the transmitting UE for example in terms of reference signal receiving power (RSRP), reference signal receiving quality (RSRQ), reference signal strength indicator (RSSI), signal to interference plus noise ratio (SINR), signal to interference ratio (SIR), etc.
One or more receiving UEs associated with the single destination has a shortest active time intersected with the resource selection window.
One or more receiving UEs associated with the single destination has a longest active time intersected with the resource selection window

At block 304, the transmitting UE may perform at least one of:
selecting one or more resources to create a SL grant based on the at least one DRX active time of the at least one RX UE, or
selecting a destination based on the at least one DRX active time of at least one RX UE and at least one resource in a created SL grant.

In an embodiment, the transmitting UE may identify one or more available resources for creating a SL grant for data transmission based on one or more resources identified by a resource identification procedure and the at least one DRX active time of the at least one RX UE. The resource identification procedure may be any suitable resource identification procedure performed by the transmitting UE.

In an embodiment, the transmitting UE may find one or more candidate resources by intersecting the at least one DRX active time of at least one RX UE with a resource selection window and identify one or more available resources based on the one or more candidate resources.

In an embodiment, the above identifying step may be performed at step 204 of FIG. 2c. For example, the PHY layer of the transmitting UE performs a resource identification procedure on a set of resources defined by a function of a resource selection window and the set of Active Time indicated by MAC layer, to produce a set of available resources. For example, the PHY layer intersects the indicated DRX Active Time with a resource selection window to find a set of candidate resources. The PHY layer applies the legacy resource identification procedure on this set of candidate resources to obtain a set of available resources.

In an embodiment, the transmitting UE may select one or more resources for creating a SL grant for data transmission from one or more available resources identified by a resource identification procedure based on the at least one DRX active time of the at least one RX UE. The selecting step may be performed at step 208 of FIG. 2c. For example, the MAC layer selects resources among the reported set of resources taking into account the DRX Active Time of the relevant destinations to create a sidelink grant for data transmission.

In an embodiment, the selected destination fulfills at least one of:
the active time of one or more receiving UEs associated with the selected destination contains all resources in the created SL grant,
the active time of one or more receiving UEs associated with the destination contains a largest number of resources in the created SL grant, or.
the active time of one or more receiving UEs associated with the destination contains at least a threshold number of resources in the created SL grant.

In an embodiment, the selected destination further fulfills at least one of:
the transmitting UE contains LCH with a highest priority to the destination,
the transmitting UE has a highest number of LCHs with available data to the destination,
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

As shown in FIG. 2c, after a SL grant is created, the LCP procedure is performed to build a MAC PDU for transmission. The LCP may comprises two steps:
Step 1: A single destination is selected.
Step 2: The LCHs associated with the selected destination are selected according to some conditions as specified in clause 5.22.1.4.1.2 of TS 38.321 V16.6.0. After this, the MAC layer allocates SL resources to logical channels following the priority order as specified in clause 5.22.1.4.1.3 of TS 38.321 V16.6.0, to build a MAC PDU.

Different from selection criteria of Destination in the existing LCP procedure as specified in clause 5.22.1.4.1.2 of TS 38.321 V16.6.0, we focus on modifying Step 1 above based on both the Active Time of the destinations which have data available in the LCHs and the resources in the created SL grant. Further down-selection of the LCHs belonging to the selected destination (Step 2) may be performed based on LCHs priority or other rules like in the legacy LCP procedure.

According to this embodiment, the legacy resource selection procedure comprises the four steps as shown in FIG. 2c, followed by selecting a destination based on the at least one DRX active time of at least one RX UE and at least one resource in a created SL grant.

In this embodiment, the transmitting UE may selecting a destination based on the at least one DRX active time of at least one RX UE and at least one resource in a created SL grant in the process of LCP to ensure that MAC PDU built for transmission is suitable for transmission using the resources in the created sidelink grant. The embodiment aims at ensuring that the transmitting UE considers the Active Time of the different destinations associated with the LCHs when selecting which LCH(s) to become part of the MAC PDU.

FIG. 3b shows a flowchart of a method according to another embodiment of the present disclosure, which may be performed by an apparatus implemented in or at or as a transmitting UE or communicatively coupled to the transmitting UE. As such, the apparatus may provide means or modules for accomplishing various parts of the method 320 as well as means or modules for accomplishing other processes in conjunction with other components. For some parts which have been described in the above embodiments, the description thereof is omitted here for brevity.

At block 322, the transmitting UE may obtain at least one DRX active time of at least one RX UE. A destination is associated with a single or multiple RX UEs. Block 322 is same as block 302 of FIG. 3a.

At block 324, the transmitting UE may perform at least one of:
selecting one or more resources to create a SL grant based on the at least one DRX active time of the at least one RX UE, or.
selecting a destination based on the at least one DRX active time of at least one RX UE and at least one resource in a created SL grant.

Block 324 is same as block 304 of FIG. 3a.

At block 326, the transmitting UE may determine whether the selected one or more resources for creating the SL grant for data transmission fulfills at least one first condition and at least one second condition. The at least one first condition may comprise any suitable condition.

The at least one second condition may comprise any suitable condition.

At block 328, the transmitting UE may trigger a new resource identification procedure based on the at least one DRX active time of at least one RX UE when none of the at least one first condition is fulfilled.

In an embodiment, the at least one first condition comprises at least one of:
an overlapping in a time domain between one or more DRX active time of one or more receiving UEs associated with a destination and the one or more resources identified by a resource identification procedure exceeds a certain threshold, or
an overlapping in a time domain between one or more DRX active time of one or more receiving UEs associated with a destination and the one or more resources identified by a resource identification procedure has at least a predefined number of slots belonging to a Discontinuous Reception (DRX) Timer.

For example, the overlapping in the time domain between the Active Time of the destination and the set of resources for example reported as described step 206 in FIG. 2c exceeds a certain threshold. The threshold can be set to ensure enough resources are found to create a SL grant.

The overlapping in the time domain between the Active Time of the destination and the set of resources for example reported as described step 206 in FIG. 2c has at least x slots belonging to a certain DRX Timer. The value of x may be any suitable value. For example, the DRX Timer is the sl-drx-OnDuration timer. By doing so, the Active Time corresponding to regularly activated timers is prioritized over the Active Time corresponding to conditionally activated timers (e.g., the Retransmission Timer.)

In an embodiment, the at least one second condition comprises at least one of:
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

For example, the destination currently has data available in a LCH or MAC CE triggered. The destination currently has data available in a LCH or MAC CE triggered for the destination. The destination currently has data available in LCHs and at least one LCH has priority larger than a threshold or MAC CE triggered. The destination currently has data available in LCHs and all of the LCHs have priority larger than a threshold or MAC CE triggered. The destination containing MAC CE or data of LCH with highest priority among all LCHs with data available. The destination containing largest data volume in buffer or containing data volume above a threshold. The destination containing data or MAC CE which is delay critical, e.g., with lowest PDB, or queuing delay is above a threshold. The destination associated with a given UE capability or UE category. The destination with highest remaining battery life or remaining battery life above a threshold. The destination with highest measured radio channel quality towards the UE in terms of RSRP, RSRQ, RSSI, SINR, SIR etc. In case the Tx UE is a remote UE, the destination of the relay UE if the Tx UE has Uu data available and the highest priority of SL LCH(s) carrying the Uu traffic is higher than a (pre) configured threshold. In case the Tx UE is a relay UE, the destination of the remote UE if the Tx UE has Uu data available and the highest priority of SL LCH(s) carrying the Uu traffic is higher than a (pre) configured threshold.

FIG. 3c shows a flowchart of a method according to another embodiment of the present disclosure, which may be performed by an apparatus implemented in or at or as a transmitting UE or communicatively coupled to the transmitting UE. As such, the apparatus may provide means or modules for accomplishing various parts of the method 330 as well as means or modules for accomplishing other processes in conjunction with other components. For some parts which have been described in the above embodiments, the description thereof is omitted here for brevity.

At block 332, the transmitting UE may transmit data to a destination using one or more resources in the created SL grant. As described in the above embodiments, the transmitting UE may select one or more resources to create a SL grant based on the at least one DRX active time of the at least one RX UE. Alternatively, the transmitting UE may select one or more resources to create a SL grant as described in FIG. 2c. As described in the above embodiments, the transmitting UE may select a destination based on the at least one DRX active time of at least one RX UE and at least one resource in a created SL grant. Alternatively, the transmitting UE may select a destination as described in LCP.

FIG. 3d shows a flowchart of a method according to another embodiment of the present disclosure, which may be performed by an apparatus implemented in or at or as a transmitting UE or communicatively coupled to the transmitting UE. As such, the apparatus may provide means or modules for accomplishing various parts of the method 330 as well as means or modules for accomplishing other processes in conjunction with other components. For some parts which have been described in the above embodiments, the description thereof is omitted here for brevity.

At block 332, the transmitting UE may obtain at least one Discontinuous Reception (DRX) active time of at least one receiving (RX) UE.

At block 334, the transmitting UE may select one or more resources to create a sidelink (SL) grant based on the at least one DRX active time of the at least one RX UE.

At block 336, the transmitting UE may select a destination based on the at least one DRX active time of at least one RX UE and at least one resource in a created SL grant.

In an embodiment, a destination is associated with a single or multiple RX Ues.

In an embodiment, selecting one or more resources to create a SL grant based on the at least one DRX active time of the at least one RX UE comprises: determining whether one or more available resources for creating the SL grant for data transmission fulfills at least one first condition. The at least one first condition comprises: an overlapping in a time domain occurs between the at least one DRX active time of at least one RX UE and the one or more available resources identified by a resource identification procedure.

In an embodiment, selecting one or more resources to create a SL grant based on the at least one DRX active time of the at least one RX UE further comprises: selecting the one or more resources for creating a SL grant for data transmission from the one or more available resources identified by a resource identification procedure, based on the at least one DRX active time of the at least one RX UE.

FIG. 3e shows a flowchart of a method according to another embodiment of the present disclosure, which may be performed by an apparatus implemented in or at or as a transmitting UE or communicatively coupled to the transmitting UE. As such, the apparatus may provide means or modules for accomplishing various parts of the method 340 as well as means or modules for accomplishing other processes in conjunction with other components. For some parts which have been described in the above embodiments, the description thereof is omitted here for brevity.

At block 342, the transmitting UE may determine whether the one or more available resources for creating the SL grant for data transmission fulfills at least one second condition.

FIG. 4a shows a flowchart of a method according to another embodiment of the present disclosure, which may be performed by an apparatus implemented in or at or as a receiving user equipment (RX) UE or communicatively coupled to the RX UE. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the RX UE may receive data in a sidelink (SL) grant from a transmitting (TX) UE. One or more resources is selected to create a SL grant based on the at least one DRX active time of at least one RX UE. A destination is selected based on the at least one DRX active time of at least one RX UE identified by at least one destination and at least one resource in a created SL grant. A destination is associated with a single or multiple RX UEs.

In an embodiment, the at least one DRX active time of at least one RX UE is selected based on a selection rule.

In an embodiment, the transmitting UE has data in at least one logical channel, LCH, or a medium access control, MAC, control element, CE, to be transmitted to the at least one RX UE at a time of a resource selection trigger.

In an embodiment, the selection rule comprises at least one of:
selecting one or more DRX active time of one or more receiving UEs associated with a single destination among the at least one RX UE. One or more receiving UEs associated with the single destination have active time overlapping with one or more DRX active time of one or more receiving UEs associated with a largest number of other destinations in at least one RX UE,
selecting one or more DRX active time of one or more receiving UEs associated with K destinations among the at least one RX UE. The K destinations are the first K destinations ranked in a descending order of a number of other destinations having overlapping Active Time with, and a value of K can be configured or preconfigured or predefined,
selecting one or more DRX active time of one or more receiving UEs associated with a single destination among the at least one RX UE. The single destination is associated with a SL LCH of a highest priority,
selecting one or more DRX active time of one or more receiving UEs associated with N destinations. The N destinations is selected according to a number of other destinations with which there are overlapped active time or according to highest SL LCH priority associated with a destination or randomly selected,
selecting one or more DRX active time of one or more receiving UEs associated with a single destination among the at least one RX UE. The single destination has a highest number of associated receiving UEs;
selecting one or more DRX active time of one or more receiving UEs associated with one or more destinations among the at least one RX UE. The transmitting UE is expecting to have data and/or MAC CE to transmit to the one or more destinations within a time period,
selecting one or more DRX active time of one or more receiving UEs associated with a single destination among the at least one RX UE. The single destination is associated with a relay UE and at least one SL LCH carrying Uu traffic has a priority higher than a threshold,
selecting one or more DRX active time of one or more receiving UEs associated with a single destination among the at least one RX UE. The single destination is associated with a remote UE and at least one SL LCH carrying Uu traffic has a priority higher than a threshold,
selecting one or more DRX active time of one or more receiving UEs associated with one or more destinations among at least one RX UE. At least one receiving UE associated with the one or more destinations is within a predefined distance to the transmitting UE,
selecting one or more DRX active time of one or more receiving UEs associated with a single destination among the at least one RX UE. The transmitting UE contains largest data volume in buffer or contains data volume above a threshold to be transmitted to the single destination,
selecting one or more DRX active time of one or more receiving UEs associated with a single destination among the at least one RX UE. The transmitting UE contains data or MAC CE to be transmitted to the single destination which is delay critical or whose queuing delay is above a threshold,
selecting one or more DRX active time of one or more receiving UEs associated with a single destination among the at least one RX UE. One or more receiving UEs associated with the single destination is associated with a given UE capability or UE category,
selecting one or more DRX active time of one or more receiving UEs associated with a single destination among the at least one RX UE. The one or more receiving UEs associated with the single destination has a highest remaining battery life or remaining battery life above a threshold,
selecting one or more DRX active time of one or more receiving UEs associated with a single destination among the at least one RX UE. The one or more receiving UEs associated with the single destination has a highest measured radio channel quality towards the transmitting UE,
selecting one or more DRX active time of one or more receiving UEs associated with a single destination among the at least one RX UE. One or more receiving UEs associated with the single destination has a shortest active time intersected with the resource selection window, or
selecting one or more DRX active time of one or more receiving UEs associated with a single destination among the at least one RX UE. One or more receiving UEs associated with the single destination has a longest active time intersected with the resource selection window.

In an embodiment, one or more available resources for creating a SL grant for data transmission is identified based on one or more resources identified by a resource identification procedure and the at least one DRX active time of the at least one RX UE

In an embodiment, one or more available resources for creating a SL grant for data transmission is identified by finding one or more candidate resources by intersecting the at least one DRX active time of at least one RX UE with a resource selection window and identifying one or more available resources based on the one or more candidate resources.

In an embodiment, the one or more resources for creating a SL grant for data transmission is selected from one or more available resources identified by a resource identification procedure based on the at least one DRX active time of the at least one RX UE.

In an embodiment, the selected one or more resources for creating the SL grant for data transmission fulfills at least one first condition and at least one second condition.

In an embodiment, a new resource identification procedure is triggered based on the at least one DRX active time of at least one RX UE when none of the at least one first condition is fulfilled.

In an embodiment, the at least one first condition comprises at least one of:
an overlapping in a time domain between one or more DRX active time of one or more receiving UEs associated with a destination and the one or more resources identified by a resource identification procedure exceeds a certain threshold, or
an overlapping in a time domain between one or more DRX active time of one or more receiving UEs associated with a destination and the one or more resources identified by a resource identification procedure has at least a predefined number of slots belonging to a Discontinuous Reception (DRX) Timer.

In an embodiment, the at least one second condition comprises at least one of:
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

In an embodiment, the selected destination fulfills at least one of:
the active time of one or more receiving UEs associated with the selected destination contains all resources in the created SL grant,
the active time of one or more receiving UEs associated with the destination contains a largest number of resources in the created SL grant, or
the active time of one or more receiving UEs associated with the destination contains at least a threshold number of resources in the created SL grant.

In an embodiment, the selected destination further fulfills at least one of:
the transmitting UE contains LCH with a highest priority to the destination,
the transmitting UE has a highest number of LCHs with available data to the destination,
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

In an embodiment, the receiving UE is a relay UE or a remote UE.

FIG. 4b shows a flowchart of a method according to another embodiment of the present disclosure, which may be performed by an apparatus implemented in or at or as a receiving user equipment (RX) UE or communicatively coupled to the RX UE. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, the RX UE may receive data in a sidelink (SL) grant from a transmitting (TX) UE.

In an embodiment, one or more resources is selected to create a SL grant based on the at least one DRX active time of at least one RX UE.

In an embodiment, a destination is selected based on the at least one DRX active time of at least one RX UE associated with the destination, and at least one resource in the created SL grant.

In an embodiment, a destination is associated with a single or multiple RX UEs.

In an embodiment, one or more resources is selected to create a SL grant based on the at least one DRX active time of at least one RX UE comprises: whether one or more available resources for creating the SL grant for data transmission fulfills at least one first condition is determined, the one or more resources is selected for creating a SL grant for data transmission from the one or more available resources identified by a resource identification procedure, based on the at least one DRX active time of the at least one RX UE.

In an embodiment, the at least one first condition comprises: an overlapping in a time domain occurs between the at least one DRX active time of at least one RX UE and the one or more available resources identified by a resource identification procedure.

FIG. 5 shows a flowchart of a method according to another embodiment of the present disclosure.

In this embodiment, the TX UE selects a set of Active Time of RX UE(s), and based on the selected set of Active Time, the TX UE performs a resource identification to produce a set of available resources.

The resource selection procedure may work as follows:
Step 501: Having data in some logical channel (LCH) at MAC layer (or at least one MAC CE has been triggered) triggers a resource selection.
Step 501′: MAC layer selects a set of Active Time of RX UE(s) according to the first selection rule and indicates the set of Active Time to PHY layer.
Step 502: PHY layer performs a resource identification procedure on a set of resources defined by a function of a resource selection window and the set of Active Time indicated by MAC layer, to produce a set of available resources.
Step 502-1: PHY layer intersects the indicated DRX Active Time with a resource selection window to find a set of candidate resources.
Step 502-2: PHY layer applies the legacy resource identification procedure on this set of candidate resources to obtain a set of available resources.
Step 503: The set of available resources is reported to MAC layer.
Step 504: MAC layer randomly selects resources among the reported set of resources to create a sidelink grant for data transmission.

Comparing to the legacy resource selection procedure as shown in FIG. 2c, a new step (Step 501′) is added, and Step 502 is modified to take into account the set of Active Time. The remaining steps (Step 501, 503, 504) are unchanged.

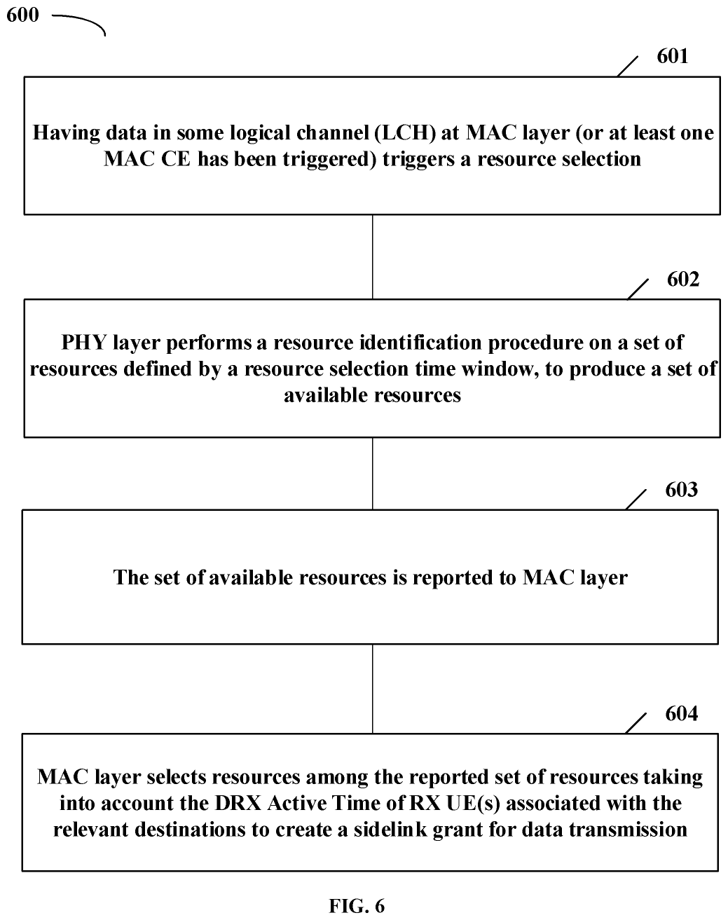

FIG. 6 shows a flowchart of a method according to another embodiment of the present disclosure.

In this embodiment, the TX UE selects resources to create a SL grant based on a set of available resources and a set of Active Time of RX UE(s) in order to maximize the utility of the SL grant.

The resource selection procedure may work as follows:
Step 601: Having data in some logical channel (LCH) at MAC layer triggers a resource selection.
Step 602: PHY layer performs the legacy resource identification procedure on a resource selection window to produce a set of available resources (i.e., there is no extra restriction in this step).
Step 603: The set of available resources is reported to MAC layer.
Step 604: MAC layer selects resources among the reported set of resources taking into account the DRX Active Time of RX UE(s) associated with the relevant destinations to create a sidelink grant for data transmission.

Comparing to the legacy resource selection procedure as shown in FIG. 2c, only Step 604 is changed to take into account the Active Time of RX UE(s) associated with the relevant destinations. Specifically, resources in Step 604 are not selected randomly as in the legacy resource selection procedure but selected according to the DRX Active Time of RX UE(s) associated with the relevant destinations.

In some cases, Step 604 can be combined with the LCP.

Hereinafter, the solutions will be further described as follows.

Some embodiments of the disclosure proposes several solutions to the open question posed above, i.e., how to use the information about DRX Active time of potential RX UEs to maximize the utility of a SL grant. The proposed solutions include:

Rules to select a set DRX Active Time will be used to limit the resources that can be used to build a SL grant.

Rules to select one or more resources to create a SL grant based on the DRX Active Time of RX UEs.

Rules to select a destination whose data in the LCHs can be transmitted using a SL grant, taking into account the DRX Active Time of destinations.

The proposed solutions help maximize the utility of a SL grant under the condition that one or more RX UEs corresponding to TX UE is operating under DRX.

Some embodiments of the disclosure are described in the context of 3GPP sidelink, where UEs operating using SL communicate directly with each other, without sending the information through the base station. In this invention, we focus on 3GPP technology (NR SL) and terminology. Nevertheless, most of the embodiments are applicable to any kind of device-to-device (D2D) communications with respect to sensing operations and discontinuous reception (DRX).

We use the term “resource selection” for both resource selection and resource reselection. Active Time denotes the DRX Active Time of one or more UEs, which is typically clear from the context.

We use the term “destination” to denote one or more UEs associated with a single destination ID (e.g., a MAC-layer ID). In case of unicast communication, typically a destination is associated with a single RX UE, while in the case of groupcast or broadcast, a destination can be associated with multiple RX UEs.

The solutions proposed in this section are concerned with the resource selection process performed by the TX UE, considering the TX UE's knowledge about the Active Time of the potential RX UEs. How the TX UE acquires the knowledge of the Active Time is out of scope of this disclosure.

Our starting point is the legacy resource selection procedure at a UE, consisting of four main steps as presented in FIG. 3c:
Step 1: Having data in some logical channel (LCH) at MAC layer (or at least one MAC CE has been triggered) triggers a resource selection.
Step 2: PHY layer performs a resource identification procedure on a set of resources defined by a resource selection window, to produce a set of available resources.
Step 3: The set of available resources is reported to MAC layer.
Step 4: MAC layer randomly selects resources among the reported set of resources to create a sidelink grant for data transmission.

Note that, eventually, the sidelink grant is used to transmit data to a single destination (see the LCP). That is, the data intended for different destination IDs is not multiplexed in a single MAC PDU or transport block.

Based on these steps, we propose the following three solutions to take into account the DRX Active Time of RX UEs. The first solution is concerned with selecting a set of Active Time, the second solution is concerned with selecting one or more resources, and the third solution is concerned with selecting a destination whose data in the LCHs to become part of a MAC PDU. The embodiments of the proposed solutions can be combined in various meaningful ways to benefit from their individual technical advantages.

### First Solution

In the first solution, the UE selects a set of Active Time according to a first selection rule, and based on the selected set of Active Time, the UE performs a resource identification to produce a set of available resources.

According to this solution, the resource selection procedure may work as follows:
Step 1: Having data in some logical channel (LCH) at MAC layer (or at least one MAC CE has been triggered) triggers a resource selection.
Step 1′: MAC layer selects a set of Active Time according to the first selection rule and indicates the set to PHY layer.
Step 2: PHY layer performs a resource identification procedure on a set of resources defined by a function of a resource selection window and the set of Active Time indicated by MAC layer, to produce a set of available resources. E.g.,
Step 2-1: PHY layer intersects the indicated DRX Active Time with a resource selection window to find a set of candidate resources.
Step 2-2: PHY layer applies the legacy resource selection procedure on this set of candidate resources to obtain a set of available resources.
Step 3: The set of available resources is reported to MAC layer.
Step 4: MAC layer randomly selects resources among the reported set of resources to create a sidelink grant for data transmission.

Comparing to the legacy procedure, a new step (Step 1′) is added, and Step 2 is modified to take into account the Active Time. The remaining steps (Step 1,3,4) are unchanged.

Embodiments for the first solution:

In the first embodiment, the first selection rule comprises selecting the Active Time of at least one destination based on one or more of the following criteria:

Example 1: the Active Time of a single destination among the destinations which have data in the LCHs is selected, the destination has Active Time overlapping with the Active Time of the largest number of other destinations which also have data in the LCHs. The advantage of this solution is that it will maximize the possibility that a SL grant using these resources will be utilized because there are highest number of destinations sharing the selected Active Time.

Example 2: the same rule as in Example 1 but counting top K destinations in terms of the number of other destinations with overlapping Active Time.

Example 3: the Active Time of a single destination among the destinations which have data in the LCHs is selected, the destination is associated with a LCH of highest priority among the LCHs having data or a MAC CE being triggered at the time of the resource selection trigger. The advantage of this solution is that the set of resources selected before building the SL grant is optimized for transmissions to that single destination since resources outside the Active Time of that destination are excluded in the first place (before building a SL grant). This option works most efficiently when the UE is mainly interested in transmitting only data that are already available in the LCHs (i.e., not considering data that might be available in the LCHs after the resource selection trigger) and has clear criteria for selecting a destination given such the data.

Example 4: The Active Time of N destinations whose LCHs have data at the time of the resource selection trigger is selected. N is an integer larger than 1 and smaller than or equal to the total number of destinations whose LCHs have data or having MAC CE triggered at the time of the resource selection trigger. The difference compared to Example 3 is that resources useful for multiple destinations (who already have data in the LCHs) are considered before building the SL grant and the LCP, leaving the work of selecting a single destination to a later stage, e.g., the LCP. Therefore, compared to Example 3, the selected resources before building the SL grant are more likely usable to data that are available in the LCHs after resource selection trigger (see also Example 5 below). The N destinations may be selected according to rule in Example 1 (i.e., according to the number of other destinations with which there are overlapped active time) or Example 3 (i.e., according to highest LCH priority associated with the destination) or randomly selected.

Example 5: a single destination among the destinations which have data in the LCHs is selected, the destination has highest number of associated Rx UEs (note that a destination could be associated with a single Rx UE as in unicast, or with multiple Rx UEs as in groupcast/broadcast). This option aims at maximizing the number of Rx UEs receiving the messages.

Example 6: The Active Time of one or more destinations to which the UE is expecting to have data to transmit within a certain time period (although such data have not yet available in the LCHs at the time of resource selection trigger). The exact value or the upper limit of this time period can be (pre)-configured or up to UE implementation, taking into account UE's complexity. Examples of the data of this type include at least one of the following:

Data that is expected to arrive shortly due to the periodic nature of the data traffic source. E.g., there are messages that are generated by higher layer every x milliseconds and based on the most recent arrival time of such messages, the UE expects that the next message is arriving soon.

Data that the UE is going to generate, in response to a previous message that the UE has received. For example, the UE has received a CSI report request from a peer UE and the UE is to transmit a CSI report message to the peer UE within a predefined time period after the request. Another example is that the UE has received a request for inter-UE coordination message and the UE is to send the coordination message within a predefined time period. Yet another example is that the UE has received a transmission or signaling from a peer UE, the UE needs to provide response or acknowledgement to the peer UE soon.

The advantage of the rule in Example 6 is that the selected resources before building the grant can be used for future data (i.e., data which arrive after the resource selection trigger and before the data transmission by the UE), which might have higher priority or more urgent to be transmitted than the data that are already available in the LCHs at the time of resource selection trigger.

Example 7: in the context of UE-to-network relaying and in case the Tx UE is a remote UE, selecting the Active Time of a destination associated with a relay UE if the highest priority of SL LCH(s) carrying Uu traffic is higher than a (pre) configured threshold.

Example 8: The Active Time of one or more destinations whose associated RX UEs are within a certain distance to the UE is selected. In this case, the UE aims at finding resources that are usable for transmission to the nearest peer UEs. Note that, as in Example 6, data for these peer UEs are not necessarily available in the LCHs at the time of resource selection trigger.

Example 9: in addition to any one of the above examples, TX UE may consider at least one of the following conditions to select one or multiple Destinations

The destination containing largest data volume in buffer or containing data volume above a threshold

The destination containing data or MAC CE which is delay critical, e.g., with lowest PDB, or queuing delay is above a threshold

The destination associated with a given UE capability or UE category

The destination with highest remaining battery life or remaining battery life above a threshold

The destination with highest measured radio channel quality towards the UE in terms of RSRP, RSRQ, RSSI, SINR, SIR etc.

The destination with shortest Active Time intersected with the selection window

The destination with longest Active Time intersected with the selection window

### Second Solution

In the second solution, the UE selects resources to create a SL grant based on a set of available resources and a set of Active Time according to a second selection rule in order to maximize the utility of the SL grant.

According to this solution, the resource selection procedure may work as follows:
Step 1: Having data in some logical channel (LCH) at MAC layer triggers a resource selection.
Step 2: PHY layer performs the legacy resource selection procedure on a resource selection window to produce a set of available resources (i.e., there is no extra restriction in this step).
Step 3: The set of available resources is reported to MAC layer.
Step 4: MAC layer selects resources among the reported set of resources taking into account the DRX Active Time of the relevant destinations according to the second selection rule to create a sidelink grant for data transmission.

Comparing to the legacy procedure, only Step 4 is changed to take into account the Active Time of the relevant destinations. Specifically, resources in Step 4 are not selected randomly as in the legacy procedure but selected according to the second selection rule.

In some cases, Step 4 can be combined with the LCP step (see FIG. 2c).

### Embodiments for the Second Solution

In the first embodiment, the second selection rule comprises selecting resources (among the reported set of resources) so that the selected resources can be used to transmit data to a destination fulfilling at least one of the following first conditions and at least one of the following second conditions:

### First Conditions:

The overlapping in the time domain between the Active Time of the destination and the reported set of resources exceeds a certain threshold. The threshold can be set to ensure enough resources are found to create a SL grant.

The overlapping in the time domain between the Active Time of the destination and the reported set of resources has at least x slots belonging to a certain DRX Timer. For example, the DRX Timer is the sl-drx-OnDuration timer. By doing so, the Active Time corresponding to regularly activated timers is prioritized over the Active Time corresponding to conditionally activated timers (e.g., the Retransmission Timer.)

### Second Conditions:

The destination currently has data available in a LCH or MAC CE triggered.

The destination currently has data available in LCHs and at least one LCH has priority larger than a threshold or MAC CE triggered.

The destination currently has data available in LCHs and all of the LCHs have priority larger than a threshold or MAC CE triggered.

The destination containing MAC CE or data of LCH with highest priority among all LCHs with data available

The destination containing largest data volume in buffer or containing data volume above a threshold

The destination containing data or MAC CE which is delay critical, e.g., with lowest PDB, or queuing delay is above a threshold

The destination associated with a given UE capability or UE category

The destination with highest remaining battery life or remaining battery life above a threshold

The destination with highest measured radio channel quality towards the UE in terms of RSRP, RSRQ, RSSI, SINR, SIR etc.

in case the Tx UE is a remote UE, the destination of the relay UE if the Tx UE has Uu data available and the highest priority of SL LCH(s) carrying the Uu traffic is higher than a (pre) configured threshold.

In the second embodiment, if none of the first conditions in the first embodiment is fulfilled, the UE triggers a resource reselection. For example, the UE may first check the first conditions, if none of them is fulfilled, the UE triggers a resource reselection without further checking the second conditions.

### Third Solution

As introduced in FIG. 2c, after a SL grant is created, the LCP procedure is performed to build a MAC PDU for transmission. The LCP consists of two steps:
Step 1: A single destination is selected.
Step 2: The LCHs associated with the selected destination are selected according to some conditions as specified in clause 5.22.1.4.1.2 of 3GPP TS 38.321 V16.6.0. After this, the MAC layer allocates SL resources to logical channels following the priority order as specified in clause 5.22.1.4.1.3 of 3GPP TS 38.321 V16.6.0, to build a MAC PDU.

In this third solution, different from selection criteria of Destination in the existing LCP procedure as specified in clause 5.22.1.4.1.2 of 3GPP TS 38.321 V16.6.0, we focus on modifying Step 1 above based on both the Active Time of the destinations which have data available in the LCHs and the resources in the created SL grant. Further down-selection of the LCHs belonging to the selected destination (Step 2) may be performed based on LCHs priority or other rules like in the legacy LCP procedure.

According to this solution, the resource selection procedure consists of the 4 steps described in FIG. 2c (or similarly specified steps), followed by the following rule applied on the destination selection of the LCP procedure.

In the third solution, the UE applies a third selection rule in the process of LCP to ensure that MAC PDU built for transmission is suitable for transmission using the resources in the created sidelink grant. The rule aims at ensuring that the UE considers the Active Time of the different destinations associated with the LCHs when selecting which LCH(s) to become part of the MAC PDU.

### Embodiments for the Third Solution

In the first embodiment, the third selection rule comprises comparing the Active Time of the destinations having data in the LCHs with the time of the resources belonging the created SL grant to select one destination. For example:

The destination whose Active Time contains all the resources in the SL grant is selected.

The destination whose Active Time contains the largest number of SL grant resources is selected.

The destination whose Active Time contains at least N of the SL grant resources is selected, where N is a (pre-) configurable parameter.

In the above examples, if more than one destination fulfills the condition of the selection rule, at least one of the following additional criteria can be applied to select a single destination, e.g.,
the destination which contains the LCH with highest priority is selected,
the destination with highest number of LCHs having data available is selected.

Besides, some criteria stated in the embodiments/examples in the first and the second solution can be applied if applicable.

FIG. 7 is a block diagram showing an apparatus suitable for practicing some embodiments of the disclosure. For example, any one of the transmitting UE or the receiving UE described above may be implemented as or through the apparatus 700.

The apparatus 700 comprises at least one processor 721, such as a digital processor (DP), and at least one memory (MEM) 722 coupled to the processor 721. The apparatus 700 may further comprise a transmitter TX and receiver RX 723 coupled to the processor 721. The MEM 722 stores a program (PROG) 724. The PROG 724 may include instructions that, when executed on the associated processor 721, enable the apparatus 700 to operate in accordance with the embodiments of the present disclosure. A combination of the at least one processor 721 and the at least one MEM 722 may form processing means 725 adapted to implement various embodiments of the present disclosure.

Various embodiments of the present disclosure may be implemented by computer program executable by one or more of the processor 721, software, firmware, hardware or in a combination thereof.

The MEM 722 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 721 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the transmitting UE, the memory 722 contains instructions executable by the processor 721, whereby the transmitting UE operates according to any of the methods related to the transmitting UE as described above.

In an embodiment where the apparatus is implemented as or at the receiving UE, the memory 722 contains instructions executable by the processor 721, whereby the receiving UE operates according to any of the methods related to the receiving UE as described above.

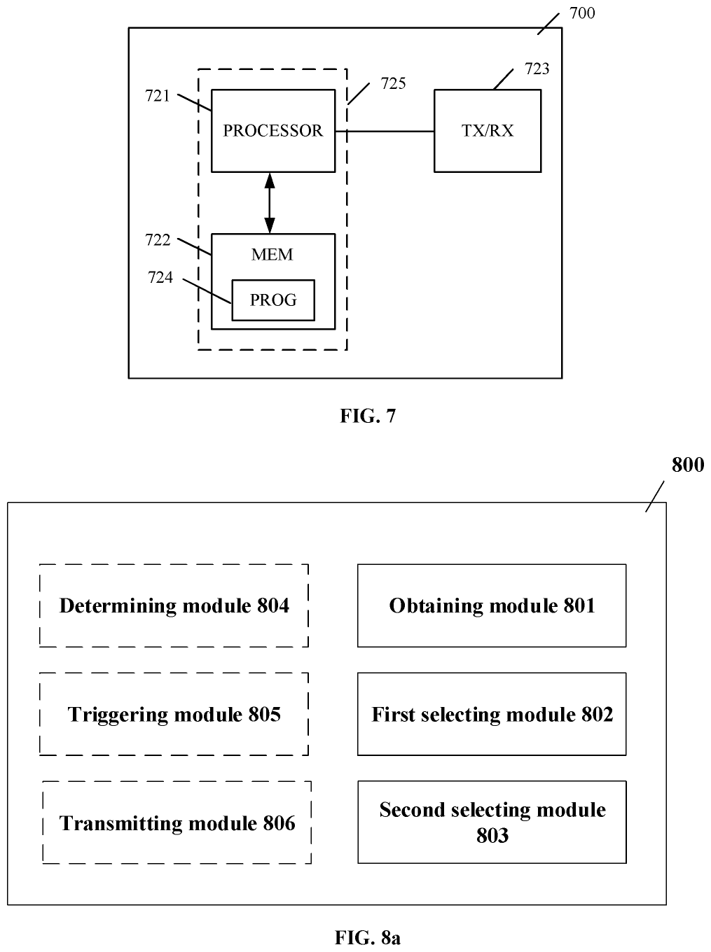

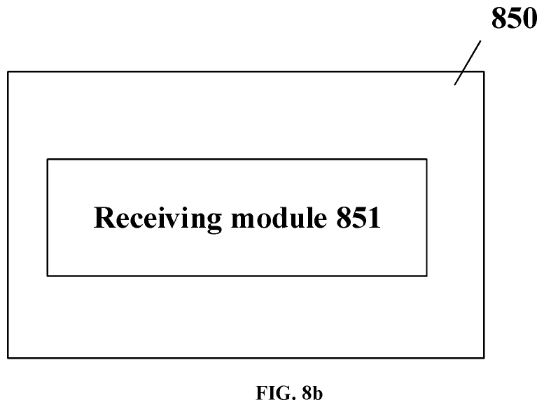

FIG. 8a is a block diagram showing a transmitting UE according to an embodiment of the disclosure. As shown, the transmitting UE 800 comprises an obtaining module 801 configured to obtain at least one Discontinuous Reception (DRX) active time of at least one receiving (RX) UE. The transmitting UE comprises a first selecting module 802 configured to select one or more resources to create a sidelink (SL) grant based on the at least one DRX active time of the at least one RX UE. The transmitting UE comprises a second selecting module 803 configured to select a destination based on the at least one DRX active time of at least one RX UE and at least one resource in a created SL grant. A destination is associated with a single or multiple RX UEs. The first selecting module is further configured to determine whether one or more available resources for creating the SL grant for data transmission fulfills at least one first condition. The at least one first condition comprises: an overlapping in a time domain occurs between the at least one DRX active time of at least one RX UE and the one or more available resources identified by a resource identification procedure. The first selecting module is further configured to select the one or more resources for creating a SL grant for data transmission from the one or more available resources identified by a resource identification procedure, based on the at least one DRX active time of the at least one RX UE.

In an embodiment, the transmitting UE 800 may further comprise a determining module 804 configured to determine whether the one or more available resources for creating the SL grant for data transmission fulfills at least one second condition.

In an embodiment, the transmitting UE 800 may further comprise a triggering module 805 configured to trigger a new resource identification procedure based on the at least one DRX active time of at least one RX UE when none of the at least one first condition is fulfilled.

In an embodiment, the transmitting UE 800 may further comprise a transmitting module 806 configured to transmitting data to a destination using one or more resources in the created SL grant.

FIG. 8b is a block diagram showing a receiving UE 850 according to an embodiment of the disclosure. As shown, the receiving UE 850 comprises a receiving module 851. The receiving module 851 may be configured to receive data in a sidelink (SL) grant from a transmitting (TX) UE. One or more resources is selected to create a SL grant based on the at least one DRX active time of at least one RX UE. A destination is selected based on the at least one DRX active time of at least one RX UE associated with the destination, and at least one resource in the created SL grant. A destination is associated with a single or multiple RX UEs. One or more resources is selected to create a SL grant based on the at least one DRX active time of at least one RX UE comprises: whether one or more available resources for creating the SL grant for data transmission fulfills at least one first condition is determined, the one or more resources is selected for creating a SL grant for data transmission from the one or more available resources identified by a resource identification procedure, based on the at least one DRX active time of the at least one RX UE. The at least one first condition comprises: an overlapping in a time domain occurs between the at least one DRX active time of at least one RX UE and the one or more available resources identified by a resource identification procedure.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the transmitting UE or the receiving UE may not need a fixed processor or memory, any computing resource and storage resource may be arranged from the transmitting UE or the receiving UE in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Embodiments herein may provide many advantages, of which a non-exhaustive list of examples follows. In some embodiments herein. The proposed solutions can maximize the utility of a SL grant under the condition that one or more RX UEs corresponding to TX UE is operating under DRX. The embodiments herein are not limited to the features and advantages mentioned above. A person skilled in the art will recognize additional features and advantages upon reading the following detailed description.

Further, the exemplary overall commutation system including the terminal device and the network node will be introduced as below.

Embodiments of the present disclosure provide a communication system including a host computer including: processing circuitry configured to provide user data; and a communication interface configured to forward the user data to a cellular network for transmission to a terminal device. The cellular network includes a base station, and/or the terminal device such as the transmitting UE and the receiving UE above mentioned.

In embodiments of the present disclosure, the system further includes the terminal device. The terminal device is configured to communicate with the base station.

In embodiments of the present disclosure, the processing circuitry of the host computer is configured to execute a host application, thereby providing the user data; and the terminal device includes processing circuitry configured to execute a client application associated with the host application.

Embodiments of the present disclosure also provide a communication system including a host computer including: a communication interface configured to receive user data originating from a transmission from a terminal device; a base station. The transmission is from the terminal device to the base station. The terminal device is above mentioned.

In embodiments of the present disclosure, the processing circuitry of the host computer is configured to execute a host application. The terminal device is configured to execute a client application associated with the host application, thereby providing the user data to be received by the host computer.

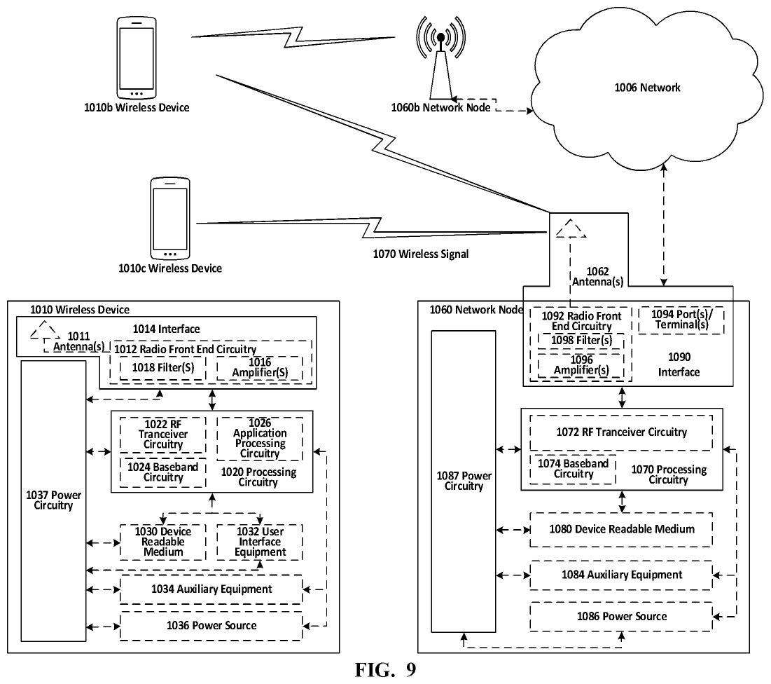

FIG. 9 is a schematic showing a wireless network in accordance with some embodiments.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 1006, network nodes 1060 (corresponding to network side node) and 1060b, and WDs (corresponding to terminal device) 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs. MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA. LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, e NB or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signaling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 9 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE. NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments. WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

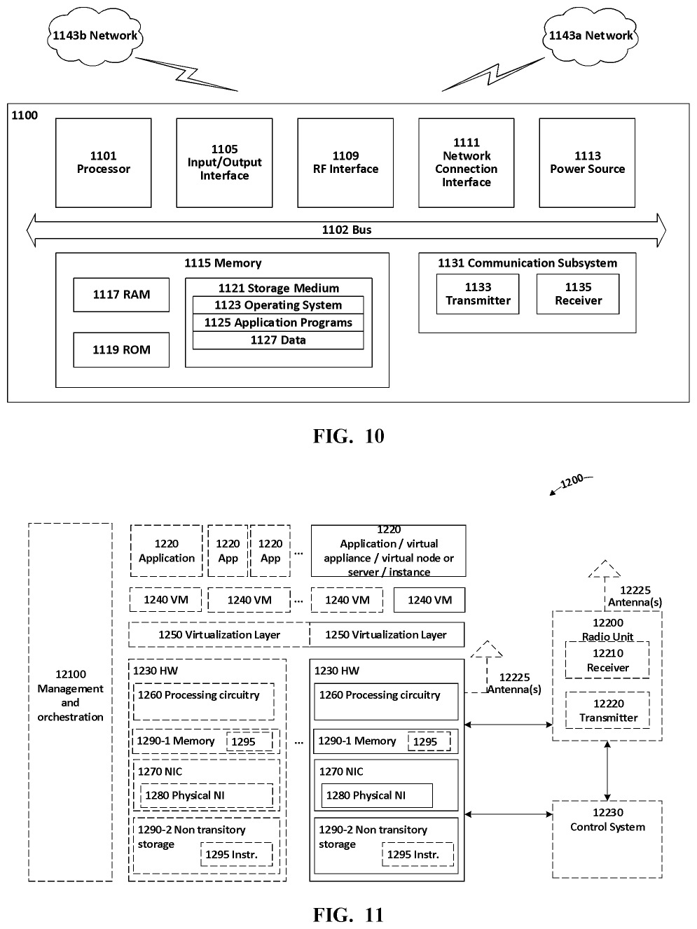

FIG. 10 is a schematic showing a user equipment in accordance with some embodiments.

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3rd Generation Partnership Project (3GPP), including a NB-IoT UE, a machine type communication (MTC) UE, and/or an enhanced MTC (eMTC) UE. UE 1100, as illustrated in FIG. 10, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 10, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

FIG. 11 is a schematic showing a virtualization environment in accordance with some embodiments.

FIG. 11 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290-1. Memory 1290-1 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 11, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV. Virtual Network Function (VNF) is responsible for handling specific network functions that run in one or more virtual machines 1240 on top of hardware networking infrastructure 1230 and corresponds to application 1220 in FIG. 11.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signaling can be effected with the use of control system 12230 which may alternatively be used for communication between the hardware nodes 1230 and radio units 12200.

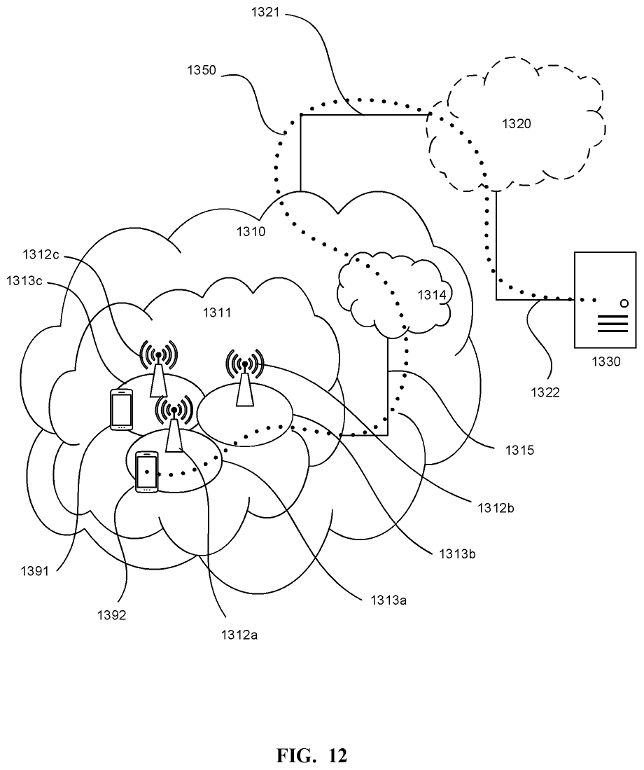

FIG. 12 is a schematic showing a telecommunication network connected via an intermediate network to a host computer in accordance with some embodiments.

With reference to FIG. 12, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312a or 1312b or 1312c.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 12 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312a or 1312b or 1312c may not or need not be informed about the past routing of an incoming downlink communication with data originating from host computer 1330 to be forwarded (e.g., handed over) to a connected UE 1391. Similarly, base station 1312a or 1312b or 1312c need not be aware of the future routing of an outgoing uplink communication originating from the UE 1391 towards the host computer 1330.

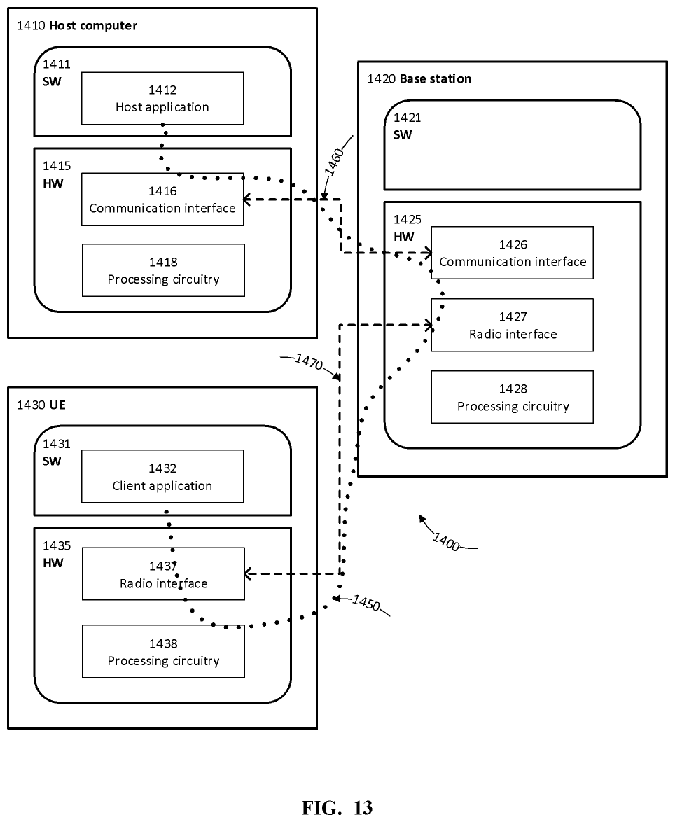

FIG. 13 is a schematic showing a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 13. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 13) served by base station 1420. Communication interface 1426 may be configured to facilitate connection 1460 to host computer 1410. Connection 1460 may be direct or it may pass through a core network (not shown in FIG. 13) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 13 may be similar or identical to host computer 1330, one of base stations 1312a, 1312b, 1312c and one of UEs 1391, 1392 of FIG. 12, respectively. This is to say, the inner workings of these entities may be as shown in FIG. 13 and independently, the surrounding network topology may be that of FIG. 12.

In FIG. 13, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may maximize the utility of a SL grant under the condition that one or more RX UEs corresponding to TX UE is operating under DRX.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

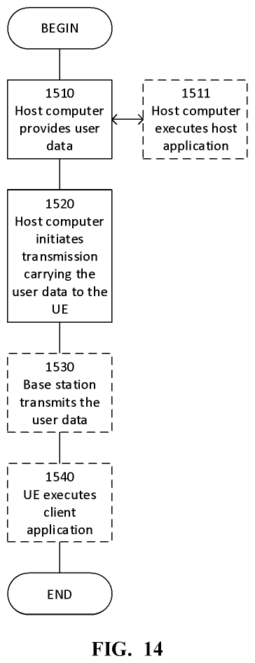

FIG. 14 is a schematic showing methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

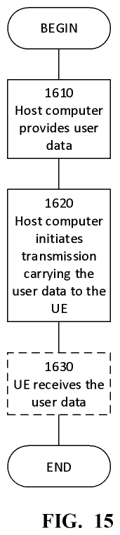

FIG. 15 is a schematic showing methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

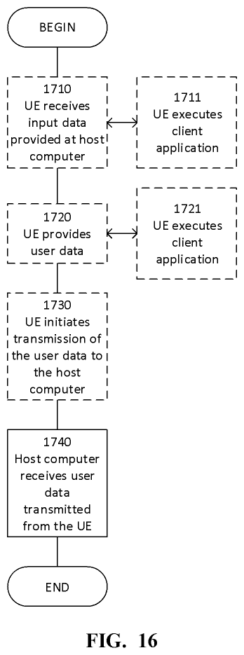

FIG. 16 is a schematic showing methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

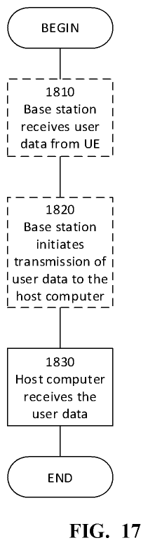

FIG. 17 is a schematic showing methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

In addition, the present disclosure may also provide a carrier containing the computer program as mentioned above. The carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape. CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-33. (canceled)

34. A method performed by a transmitting (TX) user equipment (UE), the method comprising:
obtaining at least one Discontinuous Reception (DRX) active time of at least one receiving (RX) UE;
selecting one or more resources to create a sidelink (SL) grant based on the at least one DRX active time of the at least one RX UE; and
selecting a destination based on the at least one DRX active time of at least one RX UE and at least one resource in a created SL grant,
wherein a destination is associated with a single or multiple RX UEs,
wherein selecting one or more resources to create a SL grant based on the at least one DRX active time of the at least one RX UE comprises:
determining whether one or more available resources for creating the SL grant for data transmission fulfills at least one first condition, wherein the at least one first condition comprises: an overlapping in a time domain occurs between the at least one DRX active time of at least one RX UE and the one or more available resources identified by a resource identification procedure,
selecting the one or more resources for creating a SL grant for data transmission from the one or more available resources identified by a resource identification procedure, based on the at least one DRX active time of the at least one RX UE.

35. The method according to claim 34, wherein obtaining at least one DRX active time of the at least one RX UE comprises selecting at least one DRX active time of at least one RX UE based on a selection rule.

36. The method according to claim 35, wherein the TX UE has data in at least one logical channel (LCH) or a medium access control (MAC) control element (CE) to be transmitted to the at least one RX UE at a time of a resource selection trigger.

37. The method according to claim 35, wherein the selection rule comprises at least one of:
selecting one or more DRX active time of one or more receiving UEs associated with a single destination among the at least one RX UE, wherein one or more receiving UEs associated with the single destination have active time overlapping with one or more DRX active time of one or more receiving UEs associated with a largest number of other destinations in at least one RX UE,
selecting one or more DRX active time of one or more receiving UEs associated with K destinations among the at least one RX UE, wherein the K destinations are the first K destinations ranked in a descending order of a number of other destinations having overlapping Active Time with, and a value of K can be configured or preconfigured or predefined,
selecting one or more DRX active time of one or more receiving UEs associated with a single destination among the at least one RX UE, wherein the single destination is associated with a SL LCH of a highest priority,
selecting one or more DRX active time of one or more receiving UEs associated with N destinations, wherein the N destinations is selected according to a number of other destinations with which there are overlapped active time or according to highest SL LCH priority associated with a destination or randomly selected,
selecting one or more DRX active time of one or more receiving UEs associated with a single destination among the at least one RX UE, wherein the single destination has a highest number of associated receiving UEs;
selecting one or more DRX active time of one or more receiving UEs associated with one or more destinations among the at least one RX UE, wherein the transmitting UE is expecting to have data and/or MAC CE to transmit to the one or more destinations within a time period,
selecting one or more DRX active time of one or more receiving UEs associated with a single destination among the at least one RX UE, wherein the single destination is associated with a relay UE and at least one SL LCH carrying Uu traffic has a priority higher than a threshold,
selecting one or more DRX active time of one or more receiving UEs associated with a single destination among the at least one RX UE, wherein the single destination is associated with a remote UE and at least one SL LCH carrying Uu traffic has a priority higher than a threshold,
selecting one or more DRX active time of one or more receiving UEs associated with one or more destinations among at least one RX UE, wherein at least one receiving UE associated with the one or more destinations is within a predefined distance to the transmitting UE,
selecting one or more DRX active time of one or more receiving UEs associated with a single destination among the at least one RX UE, wherein the transmitting UE contains largest data volume in buffer or contains data volume above a threshold to be transmitted to the single destination,
selecting one or more DRX active time of one or more receiving UEs associated with a single destination among the at least one RX UE, wherein the transmitting UE contains data or MAC CE to be transmitted to the single destination which is delay critical or whose queuing delay is above a threshold,
selecting one or more DRX active time of one or more receiving UEs associated with a single destination among the at least one RX UE, wherein one or more receiving UEs associated with the single destination is associated with a given UE capability or UE category,
selecting one or more DRX active time of one or more receiving UEs associated with a single destination among the at least one RX UE, wherein the one or more receiving UEs associated with the single destination has a highest remaining battery life or remaining battery life above a threshold,
selecting one or more DRX active time of one or more receiving UEs associated with a single destination among the at least one RX UE, wherein the one or more receiving UEs associated with the single destination has a highest measured radio channel quality towards the transmitting UE,
selecting one or more DRX active time of one or more receiving UEs associated with a single destination among the at least one RX UE, wherein one or more receiving UEs associated with the single destination has a shortest active time intersected with the resource selection window, or
selecting one or more DRX active time of one or more receiving UEs associated with a single destination among the at least one RX UE, wherein one or more receiving UEs associated with the single destination has a longest active time intersected with the resource selection window.

38. The method according to claim 34, wherein selecting one or more resources to create a SL grant based on the at least one DRX active time of the at least one RX UE comprises:
identifying one or more available resources for creating a SL grant for data transmission based on one or more resources identified by a resource identification procedure and the at least one DRX active time of the at least one RX UE.

39. The method according to claim 38, wherein identifying one or more available resources for creating a SL grant for data transmission based on one or more resources identified by a resource identification procedure and the at least one DRX active time of the at least one RX UE comprises:
finding one or more candidate resources by intersecting the at least one DRX active time of at least one RX UE with a resource selection window; and
identifying one or more available resources based on the one or more candidate resources.

40. The method according to claim 34, further comprising:
determining whether the one or more available resources for creating the SL grant for data transmission fulfills at least one second condition.

41. The method according to claim 40, further comprising:
triggering a new resource identification procedure based on the at least one DRX active time of at least one RX UE when none of the at least one first condition is fulfilled.

42. The method according to claim 40, wherein the at least one first condition further comprises at least one of:
an overlapping in a time domain between one or more DRX active time of one or more receiving UEs associated with a destination and the one or more resources identified by a resource identification procedure exceeds a certain threshold, or
an overlapping in a time domain between one or more DRX active time of one or more receiving UEs associated with a destination and the one or more resources identified by a resource identification procedure has at least a predefined number of slots belonging to a DDRX Timer.

43. The method according to claim 42, wherein the at least one second condition comprises at least one of:
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

44. The method according to claim 34, wherein the selected destination fulfills at least one of:
the active time of one or more receiving UEs associated with the selected destination contains all resources in the created SL grant,
the active time of one or more receiving UEs associated with the destination contains a largest number of resources in the created SL grant, or
the active time of one or more receiving UEs associated with the destination contains at least a threshold number of resources in the created SL grant.

45. The method according to claim 44, wherein the selected destination further fulfills at least one of:
the transmitting UE contains LCH with a highest priority to the destination,
the transmitting UE has a highest number of LCHs with available data to the destination,
the transmitting UE currently has data available in a SL LCH or a MAC CE to transmit to the destination,
the transmitting UE currently has data available in SL LCHs or a MAC CE to transmit to the destination, and at least one of the LCHs has a priority larger than a threshold,
the transmitting UE currently has data available in SL LCHs or a MAC CE to transmit to the destination, and all of the LCHs have a priority larger than a threshold,
the transmitting UE has data available in SL LCHs or a MAC CE to transmit to the destination, and the destination is associated with a SL LCH of a highest priority,
the transmitting UE contains largest data volume in buffer or contains data volume above a threshold to be transmitted to the destination,
the transmitting UE contains data or MAC CE to be transmitted to the destination which is delay critical or whose queuing delay is above a threshold,
one or more receiving UEs associated with the destination is associated with a given UE capability or UE category,
one or more receiving UEs associated with the destination has a highest remaining battery life or remaining battery life above a threshold,
one or more receiving UEs associated with the destination has a highest measured radio channel quality towards the transmitting UE,
the destination is associated with a relay UE and at least one SL LCH carrying Uu traffic has a priority higher than a threshold, or
the destination is associated with a remote UE and at least one SL LCH carrying Uu traffic has a priority higher than a threshold.

46. The method according to claim 34, further comprising:
transmitting data to a destination using one or more resources in the created SL grant.

47. The method according to claim 34, wherein the transmitting UE is a relay UE or a remote UE.

48. A transmitting (TX) user equipment (UE) comprising:
a processor; and
a memory coupled to the processor, said memory containing instructions executable by said processor, whereby said TX UE is operative to:
obtain at least one Discontinuous Reception (DRX) active time of at least one receiving (RX) UE;
select one or more resources to create a sidelink (SL) grant based on the at least one DRX active time of the at least one RX UE, and
select a destination based on the at least one DRX active time of at least one RX UE and at least one resource in a created SL grant,
wherein a destination is associated with a single or multiple RX UEs,
wherein select one or more resources to create a SL grant based on the at least one DRX active time of the at least one RX UE comprises:
determine whether one or more available resources for creating the SL grant for data transmission fulfills at least one first condition, wherein the at least one first condition comprises: an overlapping in a time domain occurs between the at least one DRX active time of at least one RX UE and the one or more available resources identified by a resource identification procedure,
select the one or more resources for creating a SL grant for data transmission from the one or more available resources identified by a resource identification procedure, based on the at least one DRX active time of the at least one RX UE.
